(19) United States
(12) Patent Application Publication
(10) Pub. No.: US 2026/0163624 A1
(43) Pub. Date: Jun. 11, 2026

(54) MANAGING MACHINE LEARNING BASED CHANNEL STATE INFORMATION REPORTING AT A USER EQUIPMENT

(71) Applicant: Google LLC, Mountain View, CA (US)

(72) Inventors: Chih-Hsiang WU, Taipei (TW); Chi-Lin HUANG, Taipei (TW)

(21) Appl. No.: 19/123,030

(22) PCT Filed: Oct. 31, 2023
(86) PCT No.: PCT/US2023/036513

§ 371 Date: Apr. 21, 2025

Related U.S. Application Data
(60) Provisional application No. 63/422,863, filed on Nov. 4, 2022.
(60) Provisional application No. 63/454,388, filed on Mar. 24, 2023.

(51) Int. Cl. H04B 7/06; H04L 41/16; H04W 24/10

(52) U.S. Cl. CPC H04B 7/0626; H04L 41/16; H04W 24/10

(57) ABSTRACT

This disclosure provides systems, devices, apparatus, and methods, including computer programs encoded on storage media, for managing ML-based CSI reporting at a UE. The UE (102) receives (406) an ML model performance report configuration from a network entity (104) and transmits (408, 508c), to the network entity (104), an ML model performance report prepared according to the ML model performance report configuration. The ML model performance report conveys a performance of a current ML model used to compress CSI. The performance is based on a comparison of the CSI with a decompressed output of the current ML model.

### CROSS REFERENCE TO RELATED APPLICATIONS

This application claims the benefit of and priority to U.S. Provisional Application Ser. No. 63/422,863, entitled “MANAGING MACHINE LEARNING BASED CHANNEL STATE INFORMATION REPORTING AT A USER EQUIPMENT” filed on Nov. 4, 2022, and U.S. Provisional Application Ser. No. 63/454,388, entitled “MANAGING MACHINE LEARNING BASED CHANNEL STATE INFORMATION REPORTING AT A USER EQUIPMENT” filed on Mar. 24, 2023, each of which is expressly incorporated by reference herein in its entirety.

### TECHNICAL FIELD

The present disclosure relates generally to wireless communication, and more particularly, to managing machine learning (ML)-based channel state information (CSI) reporting at a user equipment (UE).

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, machine learning (ML) models may improve wireless performance, but ML models may also experience performance failures for certain types of channel conditions or as a result of blockages to the channel. Further, the UE and/or the network may experience difficulties in managing ML-based channel state information (CSI) reporting.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) may utilize a machine learning (ML) model to compress channel state information (CSI), thereby generating an ML-based CSI report that is shorter than a non-ML-based CSI report. The CSI reports are transmitted to a network entity (NE), such as a base station or an entity of a base station. The UE or the NE can assess the performance of using the ML-based compression by comparing the outcome of CSI decompression with the uncompressed CSI. The performance of using ML compression may degrade in time or be unsatisfactory for certain types of channel conditions. For example, if the ML model is trained using offline field data associated with some channel conditions that do not include a less common channel condition (LCCC), when this LCCC condition occurs, the performance of compressing CSI using the trained model may fall below a threshold. In addition, the channel experiencing a change as a result of blockages to the channel may also cause degradation of the ML-based CSI compression's performance.

Aspects presented herein address the UE optimizing the use of the ML model to compress CSI by monitoring the performance of the ML model, reporting the performance to the NE, and causing corrective actions, if necessary. The NE can adjust the ML model based on the detected performance failure. For example, the NE may update/switch the ML model or fallback to non-ML communication techniques with the UE. One or both of the UE and the NE may be capable of detecting an ML model failure. Whichever entity detects the ML model failure may then indicate the ML model failure to the other entity. Based on ML model monitoring, the UE and the NE can adjust CSI compression using the ML model.

According to some aspects, the UE receives an ML model performance report configuration from the NE and transmits, to the NE, an ML model performance report prepared according to the ML model performance report configuration. The ML model performance report conveys a performance of a current ML model used to compress the CSI. The performance is based on a comparison of the CSI with a decompressed output of the current ML model.

According to some aspects, the NE transmits the ML model performance report configuration to the UE and receives, from the UE, the ML model performance report prepared according to the ML model performance report configuration, as described above.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2B illustrate diagrams of example procedures for machine learning (ML)-based channel state information (CSI) compression at a UE.

FIGS. 2C-2D illustrate diagrams of example procedures for ML model performance evaluation at a UE.

FIGS. 2E-2F illustrate diagrams of example procedures for ML model performance evaluation at a network entity.

FIGS. 3A-3E are signaling diagrams that illustrate examples of ML model performance monitoring.

FIGS. 4A-4B are flowcharts of methods of wireless communication associated with ML model performance reporting.

FIGS. 5A-5B are flowcharts of methods of wireless communication associated with ML model performance reporting.

FIGS. 6A-6C are flowcharts of methods of wireless communication based on condition(s) for performing ML model performance reporting.

FIG. 7 is a flowchart of a method of wireless communication for requesting an ML-based CSI reporting configuration from the network.

FIG. 8 is a flowchart of a method of wireless communication for receiving a reporting configuration based on a request.

FIG. 9 is a flowchart of a method of wireless communication for reconfiguring a reporting configuration of a UE based on a request.

FIG. 10 is a diagram illustrating a hardware implementation for an example UE apparatus.

FIG. 11 is a diagram illustrating a hardware implementation for one or more example network entities.

### DETAILED DESCRIPTION

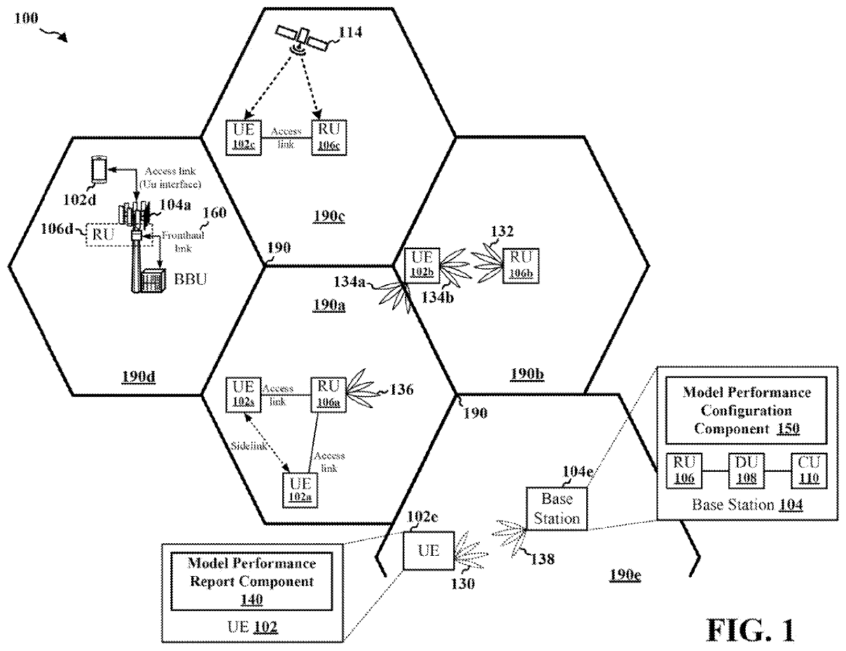

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz. and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a model performance report component 140 configured to receive a machine learning (ML) model performance report configuration from a network entity; and transmit, to the network entity, an ML model performance report prepared according to the ML model performance report configuration, the ML model performance report conveying a performance of a current ML model used to compress channel state information (CSI), the performance being based on a comparison of the CSI with a decompressed output of the current ML model.

In certain aspects, any of the base stations 104 or a network entity of the base stations 104 may include a model performance configuration component 150 configured to transmit an ML model performance report configuration to a UE; and receive, from the UE, an ML model performance report prepared according to the ML model performance report configuration, the ML model performance report conveying a performance of a current ML model used to compress CSI, the performance being based on a comparison of the CSI with a decompressed output of the current ML model.

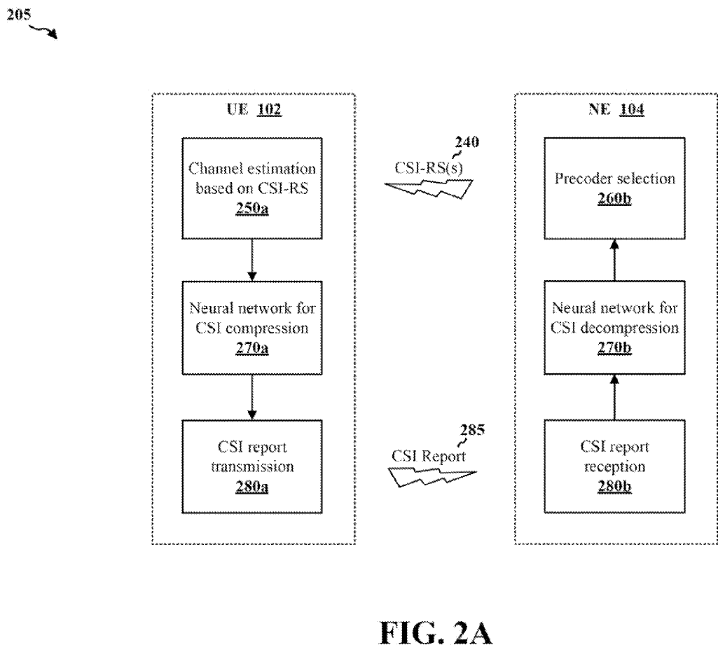

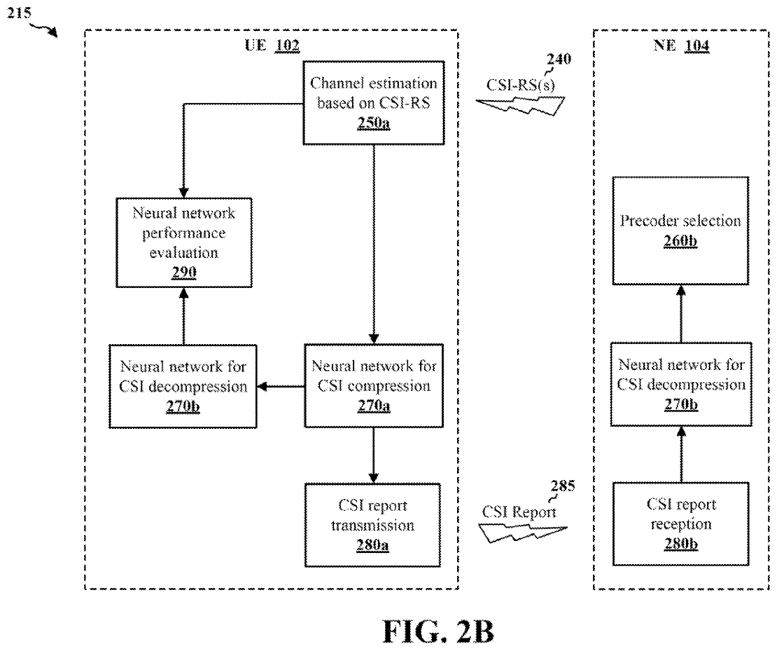

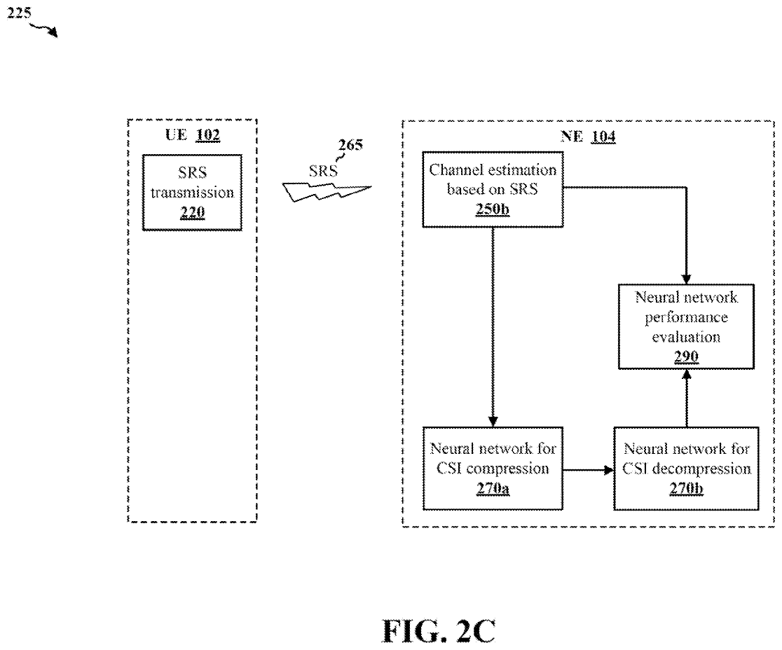

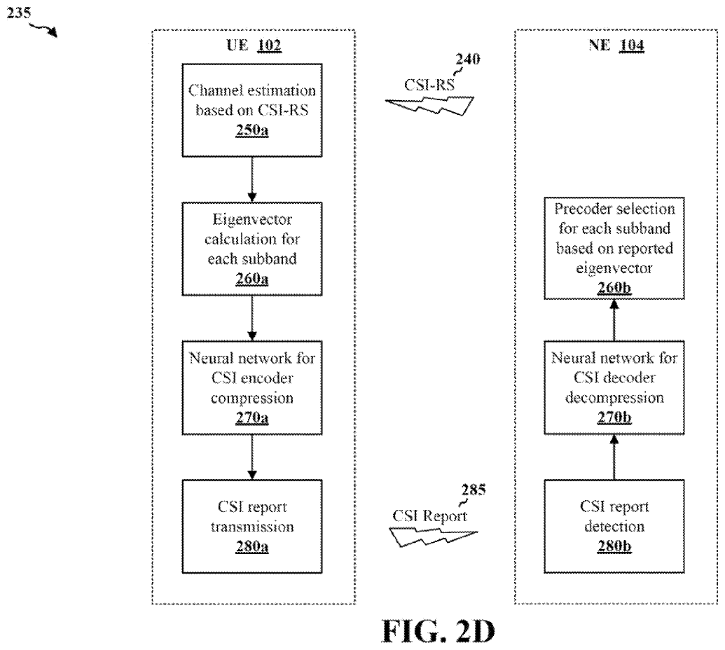

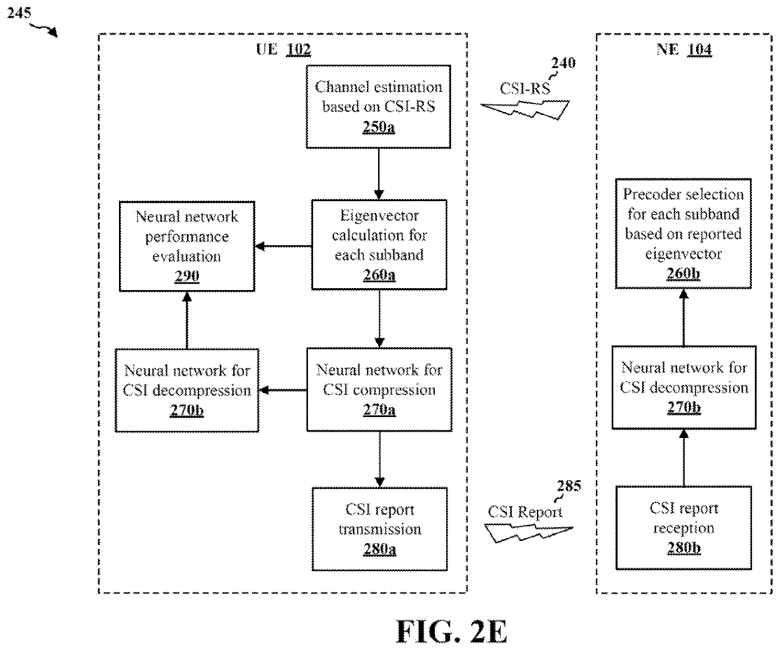

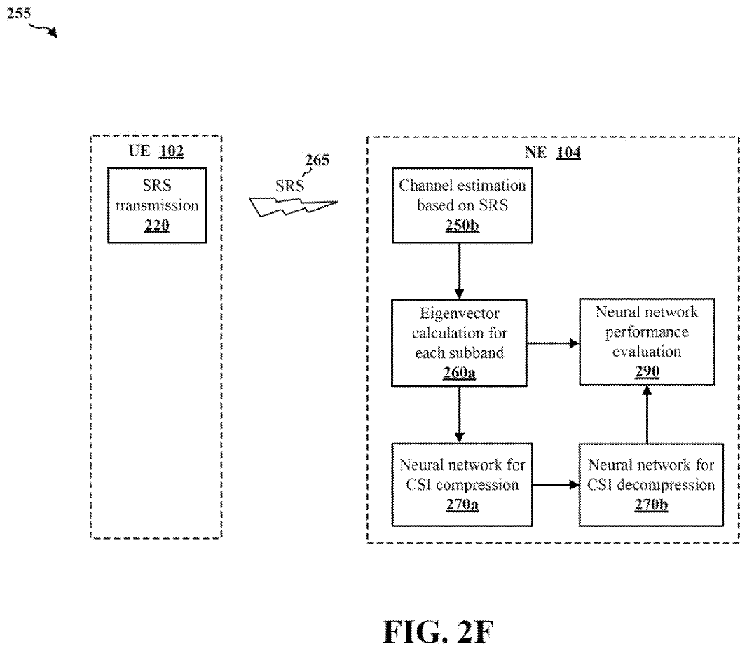

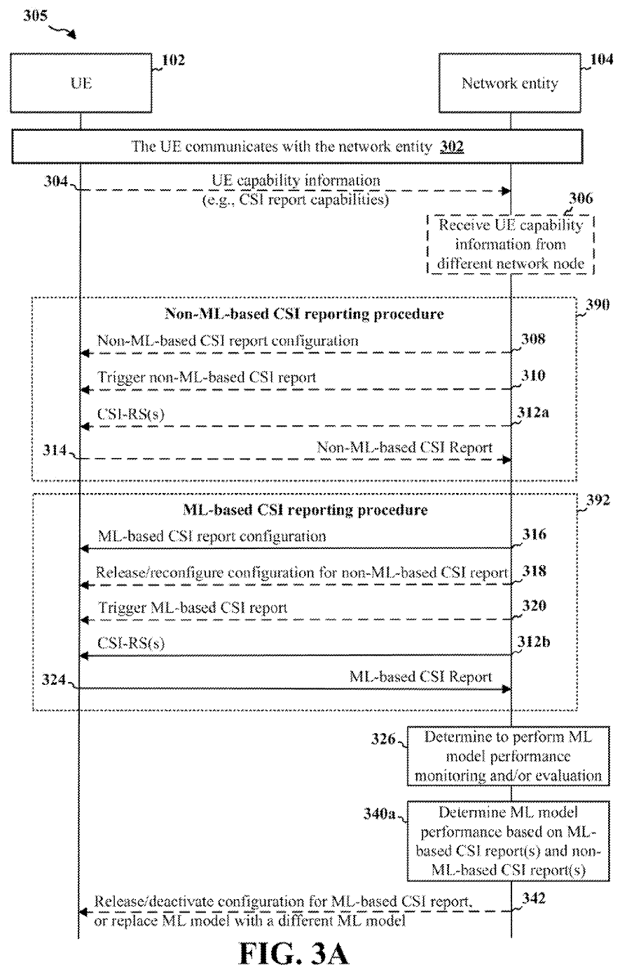

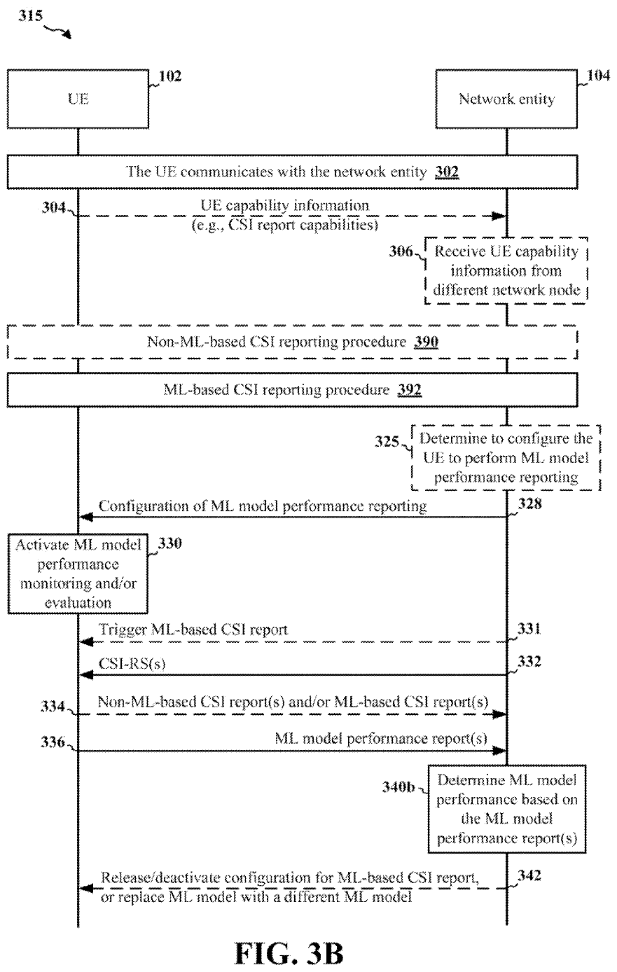

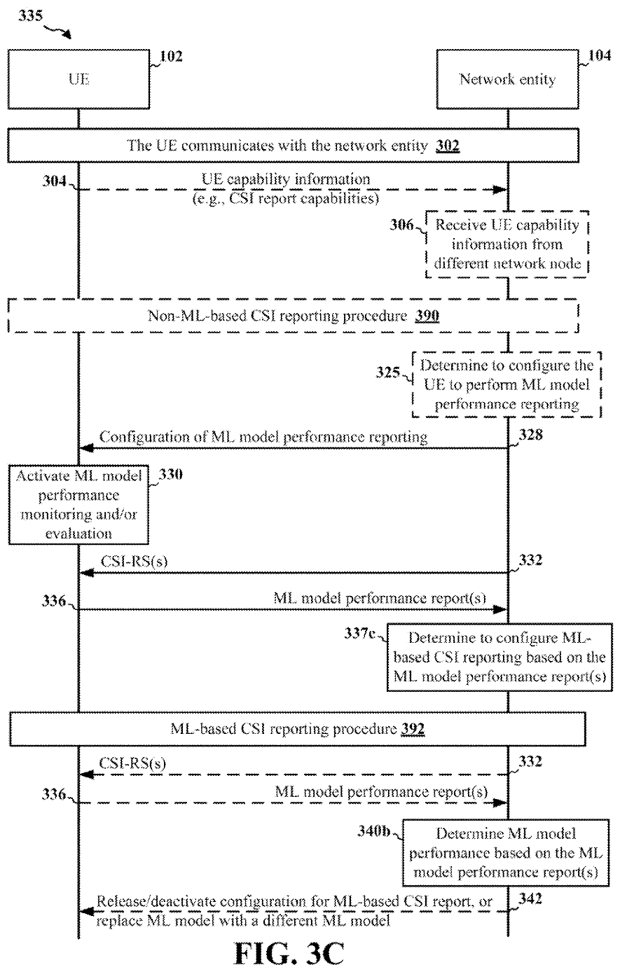

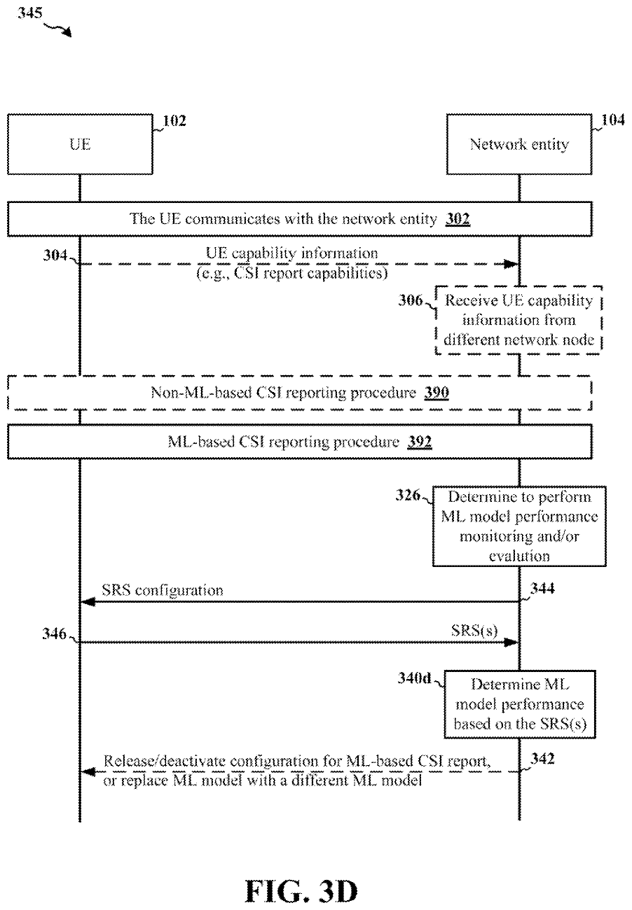

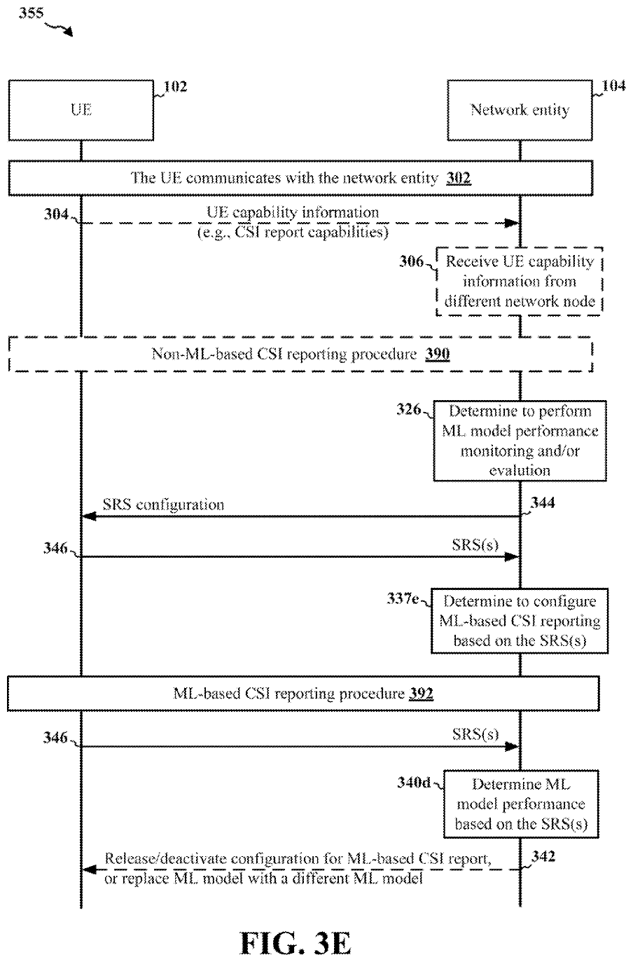

Accordingly, FIG. 1 describes a wireless communication system that may be implemented in connection with aspects of one or more other figures described herein, such as aspects illustrated in FIGS. 2A-3E. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2A illustrates a diagram 205 of an example procedure for ML-based CSI compression and/or encoder at a UE 102 and ML-based CSI decompression and/or decoder at a network entity 104, similar to FIG. 2D. The UE 102 and the network entity 104, such as a base station or an entity of a base station, may perform multiple-input multiple-output (MIMO) communications, where the network entity 104 can use CSI to select a digital precoder (e.g., precoding matrix) for the UE 102. The network entity 104 may configure CSI reporting from the UE 102 via RRC signaling (e.g., CSI-ReportConfig), where the UE 102 may use a first CSI-RS 240 as a channel measurement resource (CMR) for the UE 102 to measure a downlink channel. The network entity 104 may also configure (e.g., via the CSI-ReportConfig) a second CSI-RS as an interference measurement resource (IMR) for the UE 102 to measure interference to the downlink channel. Accordingly, the UE 102 may estimate 250a a channel between the UE 102 and the network entity 104 and obtains (e.g., determines and/or generates) (raw) CSI, based on the CSI-RS(s) 240.

The UE 102 then performs 270a CSI compression (e.g. AI/ML-based CSI generator) of the raw CSI to obtain compressed CSI. The UE 102 includes the compressed CSI in a CSI report 285 and transmits 280a the CSI report 285 to the network entity 104. In some implementations, the network entity 104 includes in CSI report 285 a Rank Indicator (RI), a Precoding Matrix Indicator (PMI), a Channel Quality Indicator (CQI), a Layer Indicator (LI), and/or a layer 1 reference signal received power (L1-RSRP), as described for FIG. 2D. In other implementations, the UE 102 refrains from including RI, PMI, CQL LI, L1-RSRP, layer 1 reference signal received quality (L1-RSRQ), and/or layer 1 signal-to-noise and interference ratio (L1-SINR) in the CSI report 285.

FIG. 2B illustrates a diagram 215 of an example procedure for CSI-RS-based AI/ML model performance monitoring and evaluation, similar to FIG. 2A, except that the UE 102 includes the neural network for CSI decompression 270b and neural network performance evaluation 290 for evaluating or determining performance of the neural network for CSI compression 270a. When or after the UE 102 performs 270a CSI compression to obtain compressed CSI, the UE 102 performs CSI decompression 270b on the compressed CSI to obtain a decompressed CSI. The UE 102 then performs 290 the neural network performance evaluation based on the decompressed CSI (inferred CSI) and the raw CSI (ground-truth CSI) to evaluate AI/ML model inference accuracy, as described for FIG. 2E.

FIG. 2C illustrates a diagram 225 of an example procedure for sounding reference signal (SRS)-based AI/ML model performance monitoring, similar to FIG. 2F, except that the network entity 104 includes the neural network for CSI decompression 270b as described for FIG. 2A. The network entity 104 directly performs 270a CSI compression on the raw CSI to obtain compressed CSI and performs CSI decompression 270b on the compressed CSI to obtain a decompressed CSI. The network entity 104 then performs 290 neural network performance evaluation based on the decompressed CSI (inferenced CSI) and the raw CSI (ground-truth CSI), as described for FIG. 2F.

The difference between the pair of CSI compression 270a and CSI decompression 270b in FIGS. 2D, 2E and 2F and the pair of CSI compression 270a and CSI decompression 270b in FIGS. 2A, 2B and FIG. 2C is that the input and output are a precoding matrix for the pair 270a and 270b in FIGS. 2D, 2E and 2F and the input and output are a channel matrix for the pair 270a and 270b in FIGS. 2A, 2B and FIG. 2C. The AI/ML model weighting parameters may be different between the pair 270a and 270b in FIGS. 2D, 2E and 2F and the pair 270a and 270b in FIGS. 2A, 2B and FIG. 2C due to different training input data type (channel matrix or precoding matrix) at AI/ML model training stage.

FIG. 2D illustrates a diagram 235 of an example procedure for ML-based CSI compression and/or encoder at a UE 102 and ML-based CSI decompression and/or decoder at a network entity 104. The UE 102 and the network entity 104, such as a base station or an entity of a base station, may perform multiple-input multiple-output (MIMO) communications, where the network entity 104 can use CSI to select a digital precoder (e.g., precoding matrix) for the UE 102. The network entity 104 may configure CSI reporting from the UE 102 via RRC signaling (e.g., CSI-ReportConfig), where the UE 102 may use a first CSI-RS 240 as a CMR for the UE 102 to measure a downlink channel. The network entity 104 may also configure a second CSI-RS (e.g., via the CSI-ReportConfig) as an IMR for the UE 102 to measure interference to the downlink channel. The first CSI-RS and the second CSI-RS can be the same CSI-RS or different CSI-RSs. Accordingly, the UE 102 may estimate 250a a channel between the UE 102 and the network entity 104 and obtains (e.g., determines and/or generates) (raw) CSI, based on the CSI-RS(s) 240.

The UE 102 then performs 260a calculation of an eigenvector for each subband and CSI compression 270a (e.g., AI/ML-based CSI generator) of the (raw) CSI to obtain compressed CSI. The UE 102 includes the compressed CSI in a CSI report 285 and transmits 280a the CSI report 285 to the network entity 104. In some implementations, the UE 102 includes in the CSI report 285 a RI, a PMI, a CQI, a LI, and/or a LI-RSRP. The CQI may be indicative of a signal-to-interference plus noise ratio (SINR) for determining a modulation and coding scheme (MCS). The LI may indicate a strongest layer, such as used for multi-user (MU)-MIMO paring of a low rank transmission with precoder selection 260b, such for phase-tracking reference signals (PT-RSs). In other implementations, the UE 102 refrains from including RI, PMI, CQI, LI, L1-RSRP, L1-RSRQ, and/or L1-SINR in the CSI report 285.

The network entity 104 may configure (e.g., based on the CSI-ReportConfig) a time domain behavior, such as periodic, semi-persistent, or aperiodic reporting, for the transmission 280a of the CSI report 285 to the network entity 104. In examples, the network entity 104 may activate/deactivate a semi-persistent CSI report from the UE 102 using a MAC-control element (MAC-CE). The network entity 104 may trigger a semi-persistent CSI report or an aperiodic CSI report from the UE 102 based on transmission of downlink control information (DCI) to the UE 102. The network entity 104 may receive a periodic CSI report from the UE 102 on physical uplink control channel (PUCCH) resources (e.g., configured via the CSI-ReportConfig). The CSI-ReportConfig may also be used to configure PUCCH resources for transmission 280a of the semi-persistent CSI report to the network entity 104. In other examples, transmission 280a of the semi-persistent CSI report to the network entity 104 may be on physical uplink shared channel (PUSCH) resources triggered by the DCI. In yet other examples, transmission 280a of the semi-persistent CSI report to the network entity 104 may be on PUCCH resources activated by the MAC-CE. The UE 102 may likewise transmit 280a the aperiodic CSI report on PUSCH resources triggered by the DCI.

For a first resource element (RE) k associated with the CSI-RS 240, the received signal at the UE 102 may be determined based on:

$${Y}_{k} = {H}_{k} {X}_{k} + {N}_{k}$$

where Hₖ indicates an effective channel including an analog beamforming weight with dimensions N_{Rx} by N_{Tx}, Xₖ corresponds to the CSI-RS 240 at RE k, Nₖ corresponds to the interference plus noise, N_{Rx} corresponds to a first number of receiving ports, and N_{Tx} corresponds to a second number of transmission ports.

For a second RE k associated with a physical downlink shared channel (PDSCH), the signal received at the UE 102 may be determined based on:

$${Y}_{k} = {H}_{k} {W}_{k} {X}_{k} + {N}_{k}$$

where Wₖ indicates the precoder. The network entity 104 may select 260b a same precoder for subcarriers within a subband (e.g., bundled in a physical resource block (PRB)).

The UE 102 can use a Type 2 CSI codebook for CSI measurement and reporting, where the precoder may be based on:

$$W = {W}_{1} {W}_{2}$$

where W₁ corresponds to a wideband precoder with dimension N_{Tx} by 2L, W₂ corresponds to a subband precoder with dimensions 2L by v, L indicates a number of beams, and v indicates a number of layers, which may correspond to RI+1. W₁ may be based on the codebook, while W₂ may be based on a power and angle associated with each transmission. Since W₂ is based on the subband and there may be multiple subbands for the CSI report 285, the UE 102 may experience a large overhead to transmit 280a the CSI report 285 to the network entity 104.

The CSI report 285 may be based on the bandwidth for the CSI-RS 240. In examples, the codebook that the network entity may use for selection 260b of W1 may be based on:

$${W}_{1} = [ \begin{matrix}B & 0 & 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

where ⊗ corresponds to a Kronecker product, L indicates the number of beams, which may be configured via RRC signaling. N₁ and N₂ correspond to the number of ports, O₁ and O₂ correspond to an oversampling factor in a horizontal and vertical domain, which may be configured via the RRC signaling. Candidate values for the oversampling factor may be based on the number of CSI-RS ports indicated via N₁ and N₂. The codebook may include precoders with different values m and n. In some examples, the candidate values may be predefined based on standardized protocols.

ML models may be implemented to compress 270a the CSI associated with the channel estimation 250a. A first v columns of an eigenvector calculated 260a for each subband of an average channel may be used as input to the ML model. In examples, the eigenvector may be input to a neural network at the UE 102 for compression 270a of the CSI encoder. The UE 102 transmits 280a, to the network entity 104, the CSI report 285 including the compressed CSI.

The network entity 104 detects 280b the CSI report 285 transmitted 280a from the UE 102 and decodes the CSI report 285 including the compressed CSI. The decoded CSI report 285 including the compressed CSI may be input to a neural network at the network entity 104 for CSI decompression 270a. That is, the neural network at the network entity 104 may decompress 270b the compressed CSI to determine a decompressed CSI. The network entity 104 may determine, from the decompressed CSI, the eigenvector used as input for the compression 270a of the CSI encoder at the UE 102. The network entity 104 may select 260b a precoder for each subband based on the determined/reported eigenvector. In some implementations, in cases where the CSI report 285 includes RI. PMI, CQI, LI and/or L1-RSRP, the network entity 104 can use the decompressed CSI, RI, PMI, CQI, LI and/or L1-RSRP to jointly determine the digital precoder (e.g., precoding matrix) or perform precoder selection 260b.

FIG. 2E illustrates a diagram 245 of an example procedure for CSI-RS-based AI/ML model performance monitoring and/or evaluation, similar to FIG. 2D, except that the UE 102 includes the neural network for CSI decompression 270b and neural network (e.g., ML model) performance evaluation 290 for evaluating or determining performance of the neural network for CSI compression 270a. When or after the UE 102 performs 270a CSI compression to obtain compressed CSI, the UE 102 performs CSI decompression 270b on the compressed CSI to obtain a decompressed CSI. The UE 102 then performs 290 the neural network performance evaluation, based on the decompressed CSI (inferred CSI) and the raw CSI (ground-truth CSI), to evaluate AI/ML model inference accuracy. In the performance evaluation 290, the UE 102 determines an AI/ML model performance metric based on the raw CSI (ground-truth CSI) and the decompressed CSI (inferred CSI) and evaluates the performance metric against a performance metric threshold. For example, if the performance metric is above or equal to the performance metric threshold, the UE 102 determines that performance of the neural network for CSI compression 270a is good. Otherwise, if the performance metric is below the performance metric threshold, the UE 102 determines that performance of the neural network for CSI compression 270a is bad. In some implementations, the UE 102 receives the performance metric threshold from the network entity 104. In other implementations, the UE 102 pre-determines or pre-stores the performance metric threshold. In yet other implementations, the performance metric threshold is defined or pre-defined in a 3GPP specification. In some implementations, the performance metric is (a value of) cosine similarity of the raw CSI (ground-truth CSI) and the decompressed CSI (inferred CSI), and the performance metric threshold is a cosine similarity threshold.

If the UE 102 unconditionally or continuously evaluates performance of the neural network for CSI compression 270a as described above, the UE 102 consumes a lot of battery power. To save battery power, the UE 102 can determine to whether to evaluate performance of the neural network for CSI compression 270a based on one or more system performance metrics, such as system throughput, block error rate (BLER), a maximum number of HARQ retransmissions, reference signal received power (RSRP), reference signal received quality (RSRQ), and/or signal-to-noise and interference ratio (SINR). For example, if the UE 102 determines that the one or more system performance metrics meet respective criterion/criteria, the UE 102 determines to evaluate performance of the neural network for CSI compression 270a. Otherwise, if the UE 102 determines that the one or more system performance metrics do not meet respective criterion/criteria, the UE 102 determines not to evaluate or stops evaluating performance of the neural network for CSI compression 270a. In some implementations, if the UE 102 determines to evaluate performance of the neural network for CSI compression 270a, the UE 102 activates the neural network for CSI decompression 270b. Otherwise, if the UE 102 determines not to evaluate or stops evaluating performance of the neural network for CSI compression 270a, the UE 102 refrains from activating or deactivates the neural network for CSI decompression 270b. The UE 102 can receive one or more RRC messages including configuration(s) of the criterion/criteria from the network entity 104. For example, the one or more RRC messages include RRCReconfiguration message(s) and/or RRCResume message(s).

For example, if the UE 102 detects or determines that BLER of DL transport blocks received by the UE 102 is above or equal to a first BLER threshold, e.g., for a first time period or immediately, the UE 102 determines to evaluate performance of the neural network for CSI compression 270a. In response to determining to evaluate performance of the neural network for CSI compression 270a, the UE 102 activates the neural network for CSI decompression 270b. Otherwise, the UE 102 determines not to evaluate or stops evaluating performance of the neural network for CSI compression 270a. In response to determining not to evaluate performance of the neural network for CSI compression 270a, the UE 102 refrains from activating or deactivates the neural network for CSI decompression 270b. In some implementations, after activating the neural network for CSI decompression 270b, if the UE 102 detects or determines that BLER of DL transport blocks received by the UE 102 is below a second BLER threshold, e.g., for a second time period or immediately, the UE 102 determines not to evaluate or stops evaluating performance of the neural network for CSI compression 270a. In some implementations, the first and second BLER thresholds are the same. In other implementations, the first and second BLER thresholds are different. In some implementations, the first and second time periods are the same. In other implementations, the first and second time periods are different. In some implementations, the UE 102 receives configurations of the first BLER threshold, second BLER threshold, first time period and/or second time period from the network entity 104. For example, the UE 102 receives a RRC message (e.g., RRCReconfiguration message or RRCResume message) including the configurations from the network entity 104. In other implementations, the UE 102 applies the first BLER threshold, second BLER threshold, first time period and/or second time period predefined in 3GPP specification(s). In yet other implementations, the UE 102 predetermines and pre-stores the first BLER threshold, second BLER threshold, first time period and/or second time period.

In another example, if the UE 102 detects or determines that a maximum number of HARQ retransmissions for one or more transport blocks received by the UE 102 is/are above or equal to a first HARQ retransmission threshold, e.g., for a first time period or immediately, the UE 102 determines to evaluate performance of the neural network for CSI compression 270a. In response to determining to evaluate performance of the neural network for CSI compression 270a, the UE 102 activates the neural network for CSI decompression 270b. Otherwise, the UE 102 determines not to evaluate or stops evaluating performance of the neural network for CSI compression 270a. In response to determining not to evaluate performance of the neural network for CSI compression 270a, the UE 102 refrains from activating or deactivates the neural network for CSI decompression 270b. In some implementations, after activating the neural network for CSI decompression 270b, if the UE 102 detects or determines that a maximum number of HARQ retransmissions for one or more transport blocks received by the UE 102 is/are below a second HARQ retransmission threshold, e.g., for a second time period or immediately, the UE 102 determines not to evaluate or stops evaluating performance of the neural network for CSI compression 270a. In some implementations, the first and second HARQ retransmission thresholds are the same. In other implementations, the first and second HARQ retransmission thresholds are different. In some implementations, the first and second time periods are the same. In other implementations, the first and second time periods are different. In some implementations, the UE 102 receives configurations of the first HARQ retransmission threshold, second HARQ retransmission threshold, first time period and/or second time period from the network entity 104. For example, the UE 102 receives a RRC message (e.g., RRCReconfiguration message or RRCResume message) including the configurations from the network entity 104. In other implementations, the UE 102 applies the first HARQ retransmission threshold, second HARQ retransmission threshold, first time period and/or second time period predefined in 3GPP specification(s). In yet other implementations, the UE 102 predetermines and pre-stores the first HARQ retransmission threshold, second HARQ retransmission threshold, first time period and/or second time period.

To save battery power, the UE 102 can evaluate performance of the neural network for CSI compression 270a on a discontinuous basis instead of a continuous basis. For example, the UE 102 receives a plurality of CSI-RS(s) in different time instances from the network entity 104. The UE 102 uses some of the plurality of CSI-RS(s) to evaluate performance of the neural network for CSI compression 270a and does not use the rest of the plurality of CSI-RS(s) to evaluate performance of the neural network for CSI compression 270a. For example, the UE 102 only evaluates performance of the neural network for CSI compression 270a based on x-th CSI-RS of every y CSI-RS(s) and does not use the rest of the plurality of CSI-RS(s) in every y CSI-RS(s) to evaluate performance of the neural network for CSI compression 270a. x and y are integers and 0<x≤y and 1<y.

FIG. 2F illustrates a diagram 255 of an example procedure for SRS-based AI/ML model performance monitoring, similar to FIG. 2A. The network entity 104 may transmit a RRC message including a SRS configuration (e.g., SRS-Config) to the UE 102 to configure the UE 102 to perform SRS transmission. SRS transmission 220 at the UE 102 transmits one or more SRS(s) 265 to the network entity 104, e.g., in accordance with the SRS configuration, and the network entity 104 receives the SRS(s) 265 from the UE 102 in accordance with the SRS configuration. In some implementations, the network entity 104 can transmit an activation command (e.g., MAC CE or DCI) to the UE 102 to activate the SRS configuration after transmitting the SRS configuration to the UE 102, and the UE 102 transmits SRS(s) in response to the activation command. The network entity 104 then performs 250b channel estimation to obtain raw CSI based on the SRS(s). After obtaining the raw CSI from the channel estimation 250b, the network entity 104 performs 260a eigenvector calculation for each subband and derives a raw precoding matrix (ground-truth precoding matrix), i.e., a plurality of eigenvectors, from the eigenvector calculation 260a. The network entity 104 performs 270a CSI compression (e.g., AI/ML-based CSI generator) of the raw precoding matrix to obtain compressed CSI. The network entity 104 derives the decompressed precoding matrix for each subband (inferred precoding matrix) from the compressed CSI. Finally, the network entity 104 performs neural network performance evaluation 290, based on the decompressed precoding matrix (inferred precoding matrix) and the raw precoding matrix (ground-truth precoding matrix), to evaluate AI/ML model inference accuracy.

In the performance evaluation 290, the network entity 104 determines or generates an AI/ML model performance metric based on the raw precoding matrix (ground-truth precoding matrix) and the decompressed CSI (inferred precoding matrix) and evaluates the performance metric against a performance metric threshold. For example, if the performance metric is above or equal to the performance metric threshold, the network entity 104 determines that performance of the neural network for CSI compression 270a is good. Otherwise, if the performance metric is below the performance metric threshold, the network entity 104 determines that performance of the neural network for CSI compression 270a is bad. In cases where the network entity 104 determines that performance of the neural network for CSI compression 270a is bad, the network entity 104 can apply at least one of: updating the ML model, switching the ML model, or fallback to non-ML CSI reporting. In some implementations, the network entity 104 receives the performance metric threshold from an operation, administration and maintenance (OAM) node or an AI/ML function node. In other implementations, the network entity 104 pre-stores the performance metric threshold. In yet other implementations, the performance metric threshold is defined or pre-defined in a 3GPP specification. In some implementations, the performance metric is cosine similarity of the raw CSI (ground-truth CSI) and the decompressed CSI (inferred CSI), and the performance metric threshold is a cosine similarity threshold.

If the network entity 104 unconditionally or continuously evaluates performance of the neural network for CSI compression 270a as described above, the network entity 104 consumes a lot of battery power. To save battery power, the network entity 104 can determine to whether to evaluate performance of the neural network for CSI compression 270a based on one or more system performance metrics, such as system throughput, block error rate (BLER), a maximum number of HARQ retransmissions, reference signal received power (RSRP), reference signal received quality (RSRQ), and/or signal-to-noise and interference ratio (SINR). For example, if the network entity 104 determines that the one or more system performance metrics meet respective criterion/criteria, the network entity 104 determines to evaluate performance of the neural network for CSI compression 270a. Otherwise, if the network entity 104 determines that the one or more system performance metrics do not meet respective criterion/criteria, the network entity 104 determines not to evaluate or stops evaluating performance of the neural network for CSI compression 270a. In some implementations, if the network entity 104 determines to evaluate performance of the neural network for CSI compression 270a, the network entity 104 activates the neural network for CSI decompression 270b. Otherwise, if the network entity 104 determines not to evaluate or stops evaluating performance of the neural network for CSI compression 270a, the network entity 104 refrains from activating or deactivates the neural network for CSI decompression 270b. In some implementations, if the network entity 104 determines to evaluate performance of the neural network for CSI compression 270a, the network entity 104 can transmit the SRS configuration and/or the activation command to the UE 102. Otherwise, if the network entity 104 determines not to evaluate performance of the neural network for CSI compression 270a, the network entity 104 may refrain from transmitting the SRS configuration and/or activation command to the UE 102. Otherwise, if the network entity 104 determines not to evaluate or stops evaluating performance of the neural network for CSI compression 270a, the network entity 104 may transmit a RRC message to the UE 102 to release the SRS configuration or transmit a deactivation command (e.g., MAC CE or DCI) to the UE 102 to deactivate the SRS configuration.

For example, if the network entity 104 detects or determines that BLER of DL transport blocks received by the UE 102 is above or equal to a first BLER threshold, e.g., for a first time period or immediately, the network entity 104 determines to evaluate performance of the neural network for CSI compression 270a. In response to determining to evaluate performance of the neural network for CSI compression 270a, the network entity 104 activates the neural network for CSI decompression 270b. Otherwise, the network entity 104 determines not to evaluate performance of the neural network for CSI compression 270a. In response to determining not to evaluate performance of the neural network for CSI compression 270a, the network entity 104 refrains from activating or deactivates the neural network for CSI decompression 270b. In some implementations, after activating the neural network for CSI decompression 270b, if the network entity 104 detects or determines that BLER of DL transport blocks received by the UE 102 is below a second BLER threshold, e.g., for a second time period or immediately, the network entity 104 determines not to evaluate performance of the neural network for CSI compression 270a. In some implementations, the first and second BLER thresholds are the same. In other implementations, the first and second BLER thresholds are different. In some implementations, the first and second time periods are the same. In other implementations, the first and second time periods are different. In some implementations, the network entity 104 receives configurations of the first BLER threshold, second BLER threshold, first time period and/or second time period from an OAM node. In other implementations, the network entity 104 applies the first BLER threshold, second BLER threshold, first time period and/or second time period predefined in 3GPP specification(s). In yet other implementations, the network entity 104 predetermines and pre-stores the first BLER threshold, second BLER threshold, first time period and/or second time period.

In another example, if the network entity 104 detects or determines that a maximum number of HARQ retransmissions for one or more transport blocks transmitted to the UE 102 is/are above or equal to a first HARQ retransmission threshold, e.g., for a first time period or immediately, the network entity 104 determines to evaluate performance of the neural network for CSI compression 270a. In response to determining to evaluate performance of the neural network for CSI compression 270a, the network entity 104 activates the neural network for CSI decompression 270b. Otherwise, the network entity 104 determines not to evaluate or stops evaluating performance of the neural network for CSI compression 270a. In response to determining not evaluate or stop evaluating performance of the neural network for CSI compression 270a, the network entity 104 refrains from activating or deactivates the neural network for CSI decompression 270b. In some implementations, after activating the neural network for CSI decompression 270b, if the network entity 104 detects or determines that a maximum number of HARQ retransmissions for one or more transport blocks transmitted to the UE 102 is/are below a second HARQ retransmission threshold, e.g., for a second time period or immediately, the network entity 104 determines not to evaluate or stops evaluating performance of the neural network for CSI compression 270a. In some implementations, the first and second HARQ retransmission thresholds are the same. In other implementations, the first and second HARQ retransmission thresholds are different. In some implementations, the first and second time periods are the same. In other implementations, the first and second time periods are different. In some implementations, the network entity 104 receives configurations of the first HARQ retransmission threshold, second HARQ retransmission threshold, first time period and/or second time period from the OAM node. In other implementations, the network entity 104 applies the first HARQ retransmission threshold, second HARQ retransmission threshold, first time period and/or second time period predefined in 3GPP specification(s). In yet other implementations, the network entity 104 predetermines and pre-stores the first HARQ retransmission threshold, second HARQ retransmission threshold, first time period and/or second time period.

To save battery power, the network entity 104 can evaluate performance of the neural network for CSI compression 270a on a discontinuous basis instead of a continuous basis. For example, the network entity 104 receives a plurality of SRS(s) in different time instances from the UE 102. The network entity 104 uses some of the plurality of SRS(s) to evaluate performance of the neural network for CSI compression 270a and does not use the rest of the plurality of SRS(s) to evaluate performance of the neural network for CSI compression 270a. For example, the network entity 104 only evaluates performance of the neural network for CSI compression 270a based on x-th SRS of every y SRS(s) and does not use the rest of the plurality of SRS(s) in every y SRS(s) to evaluate performance of the neural network for CSI compression 270a. x and y are integers and 0<x≤y and 1<y.

FIG. 3A is a signaling diagram 305 that illustrates an example of AI/ML-based CSI report. Initially, the UE 102 communicates 302 with the network entity 104. For example, the UE 102 communicates 302 UL data and/or DL data with the network 104. For example, the UL data and/or DL data can include control-plane messages such as radio resource control (RRC) messages. The UE 102 may transmit 304 a UE capability information (e.g., UECapabilityInformation message) including CSI report capability/capabilities to the network entity 104. To simplify the following description, “capabilities” is used to represent “capability/capabilities”. In some implementations, the UE 102 includes other capabilities in the UE capability information. In some implementations, the UE 102 receives a UE capability enquiry message (e.g., UECapabilityEnquiry message) from the network 104. In response, the UE 102 transmits 304 the UE capability information including the CSI report capabilities to the network entity 104. In some implementations, the UE 102 generates a container information element (IE) including the CSI report capabilities and other capabilities (i.e., capabilities other than the CSI report capabilities) and includes the container in the UE capability information. In examples, the container IE is a UE-NR-Capability IE or a UE-6G-Capability IE. Alternatively, the network entity 104 receives 306 the CSI report capabilities or container IE from a different network node than the UE 102, such as another base station (e.g., similar to the baes station 104) or a core network entity (e.g., Access and Mobility Management Function (AMF)).

In some implementations, the CSI report capabilities 304, 306 include non-ML-based CSI report capabilities. That is, the UE 102 indicates capabilities of non-ML-based reports in the non-ML-based report capabilities. Based on the non-ML-based CSI report capabilities, the network entity 104 transmits 308 configuration(s) for non-ML-based CSI report(s) to the UE 102 to configure the UE 102 to transmit non-ML-based CSI report(s). For example, the configuration(s) 308 include CSI report configuration(s) (e.g., CSI-ReportConfig IE(s)). After transmitting the configuration(s) 308, the network entity 104 can transmit 312a CSI-RS(s) to the UE 102 in accordance with the configuration(s) 308. After receiving the configuration(s) 308, the UE 102 can receive the CSI-RS(s) 312a and perform channel estimation and/or measurement(s) based on the CSI-RS(s) 312a, in accordance with the configuration(s) 308. The UE 102 generates non-ML-based CSI report(s) based on the channel estimation and/or measurement(s), and transmits 314 the non-ML-based CSI report(s) to the network entity 104. In some implementations, the UE 102 includes non-ML-based CSI in the non-ML-based CSI report(s). In some implementations, the non-ML-based CSI includes RI, PMI, CQI, LI, LI-RSRP. LI-RSRQ and/or LI-SINR.

In some implementations, the network entity 104 can transmit 308 RRC message(s) including the configuration(s) for non-ML-based CSI report(s) to the UE 102. In examples, the RRC message(s) may include RRCReconfiguration message(s). In response to each of the RRC message(s), the UE 102 can transmit a RRC response message (e.g., RRCReconfigurationComplete message) to the network entity 104. In some cases, the UE 102 is in dual connectivity with the network entity 104 (e.g., operating as a SN) and another network entity (e.g., operating as a MN not shown in FIG. 3) similar to the network entity 104. In examples, the SN 104 transmits the RRC message(s) to the UE 102 as described above. In other examples, the SN 104 transmits the RRC message(s) to the UE 102 via the MN.

In some implementations, the configuration(s) 308 includes CSI resource configuration(s) configuring the CSI-RS(s) 312a. In some implementations, the CSI-RS(s) 312a include periodic CSI-RS(s), semi-persistent CSI-RS(s) and/or aperiodic CS-RS(s). The CSI resource configuration(s) can include CSI resource configuration(s) configuring the periodic CSI-RS(s), CSI resource configuration(s) configuring semi-persistent CSI-RS(s), and/or CSI resource configuration(s) configuring aperiodic CS-RS(s). The network entity 104 can transmit 312a the periodic CSI-RS(s) on a periodic basis in accordance with the CSI resource configuration(s) configuring the periodic CSI-RS(s). The network entity 104 can transmit 312a the semi-persistent CSI-RS(s) on a semi-persistent basis in accordance with the CSI resource configuration(s) configuring the semi-persistent CSI-RS(s). The network entity 104 can transmit 312a the aperiodic CSI-RS(s) on a one-shot basis for the UE 102 to transmit aperiodic non-ML-based CSI report(s) in accordance with the aperiodic CSI resource configuration(s), as described below.

In some implementations, the network entity 104 may transmit the CSI-RS(s) 312a from N_{R} antenna ports, where N_{R} corresponds to a maximum number of downlink layers configured in the configuration(s) 308 or the CSI resource configuration(s). In some implementations, the network entity 104 may transmit the CSI-RS(s) 312a or some of the CSI-RS(s) 312a with a precoder. In other implementations, the network entity 104 may transmit the CSI-RS(s) 312a or some of the CSI-RS(s) 312a without a precoder.

In some implementations, the configuration(s) 308 includes semi-persistent non-ML-based CSI report configuration(s) configuring semi-persistent non-ML-based CSI report, and the UE 102 refrains from transmitting semi-persistent non-ML-based CSI report(s) until receiving from the network entity 104 a trigger command triggering the UE 102 to transmit semi-persistent non-ML-based CSI report(s) in accordance with the semi-persistent non-ML-based CSI report configuration(s). After transmitting the configuration(s) 308, the network entity 104 can transmit 310 to the UE 102 a trigger command triggering semi-persistent non-ML-based CSI report(s). After or in response to receiving the trigger command 310, the UE 102 performs channel estimation and/or measurement(s) on the CSI-RS(s) 312a, generates semi-persistent non-ML-based CSI report(s), and transmits 314 the semi-persistent non-ML-based CSI report(s) to the network entity 104. In some implementations, the UE 102 (periodically) transmits the semi-persistent non-ML-based CSI report(s) on PUCCH(s) that may be configured in the configuration(s) 308. In other implementations, the UE 102 (periodically) transmits the semi-persistent non-ML-based CSI report(s) on PUSCH(s) that may be configured in the configuration(s) 308 and/or the trigger command. In some implementations, the trigger command is a MAC CE. In other implementations, the trigger command is a DCI. In some implementations, the CSI-RS(s) includes periodic CSI-RS(s) and/or semi-persistent CSI-RS(s). In the case of the semi-persistent CSI-RS(s), the network entity 104 can transmit an activation command to the UE 102 to indicate that the semi-persistent CSI-RS(s) is activated. After (e.g., in response to) receiving the activation command, the UE 102 determines that transmission of the semi-persistent CSI-RS(s) is activated. In some implementations, the network entity 104 transmits the activation command before or after transmitting the trigger command. Alternatively, the network entity 104 can transmit 310 a MAC PDU including the activation command and the trigger command to the UE 102. In some implementations, the activation command is a MAC CE. In some implementations, the UE 102 activates performing channel estimation and/or measurement(s) based on the CSI-RS(s) or a portion (e.g., one or some) of the CSI-RS(s) in response to receiving the trigger command. In other implementations, the UE 102 activates performing channel estimation and/or measurement(s) based on the CSI-RS(s) or a portion (e.g., one or some) of the CSI-RS(s), in response to the semi-persistent non-ML-based CSI report configuration (s) and before receiving the trigger command.

In other implementations, the configuration(s) 308 includes periodic non-ML-based CSI report configuration(s) configuring periodic non-ML-based CSI report(s), and the UE 102 performs channel estimation and/or measurement(s) based on the CSI-RS(s), generates non-ML-based CSI report(s) based on the channel estimation and/or measurement(s), and transmits the periodic ML-based CSI report(s) 314 based on or in response to the periodic non-ML-based CSI report configuration(s). In such cases, the UE 102 activates performing channel estimation and/or measurement(s) based on the CSI-RS(s) or a portion (e.g., one or some) of the CSI-RS(s), generates periodic non-ML-based CSI report(s) based on the channel estimation and/or measurement(s), and transmits 314 the periodic non-ML-based CSI report(s) to the network entity 104, upon receiving the periodic non-ML-based CSI report configuration(s). Thus, the network entity 104 does not transmit a trigger command to the UE 102 to trigger transmission of the periodic non-ML-based CSI report(s). In some implementations, the UE 102 transmits the periodic non-ML-based CSI report(s) on PUCCH(s) that may be configured in the configuration(s) 308. In other implementations, the UE 102 transmits the periodic non-ML-based CSI report(s) on PUSCH(s) that may be configured in the configuration(s) 308 and/or DCI(s) that the UE 102 receives from the network entity 104. The DCI(s) include UL grant(s) for the UE 102 to transmit user data and are not trigger command(s).

In yet other implementations, the configuration(s) 308 includes aperiodic non-ML-based CSI report configuration(s) configuring aperiodic non-ML-based CSI report(s). For each of the aperiodic non-ML-based CSI report configuration(s), the UE 102 refrains from transmitting an aperiodic non-ML-based CSI report until receiving from the network entity 104 a trigger command triggering the UE 102 to transmit an aperiodic non-ML-based CSI report in accordance with the aperiodic non-ML-based CSI report configuration. After transmitting the aperiodic non-ML-based CSI report configuration(s), the network entity 104 can transmit 310 to the UE 102 a trigger command triggering the UE 102 to transmit an aperiodic non-ML-based CSI report in accordance with the aperiodic non-ML-based CSI report configuration. In response to the trigger command, the UE 102 performs channel estimation and/or measurement(s) on the CSI-RS, generates a single aperiodic non-ML-based CSI report, and transmits the aperiodic non-ML-based CSI report, in accordance with the aperiodic non-ML-based CSI report configuration. In some implementations, the trigger command is a MAC CE. In other implementations, the trigger command is a DCI. In some implementations, the CSI-RS includes a periodic CSI-RS, semi-persistent CSI-RS or an aperiodic CSI-RS.

The events 308, 310, 312a, and 314 are collectively referred to in FIG. 3A as a non-ML-based CSI reporting procedure 390.

In some implementations, the CSI report capabilities 304, 306 include ML-based CSI report capabilities. That is, the UE 102 indicates capabilities of ML-based CSI reports in the ML-based CSI report capabilities. Based on the ML-based CSI report capabilities, the network entity 104 transmits 316 configuration(s) for ML-based CSI report(s) to the UE 102 to configure the UE 102 to transmit ML-based CSI report(s) using a first ML model (e.g., the neural network for CSI compression 270a or 270a). For example, the UE 102 can indicate support of the first ML model or include a first identifier (ID) of the first ML model in the UE capability information, so that the network entity 104 can determine to configure the first ML model based on the indication or first ID. For example, the configuration(s) 316 include CSI report configuration(s) (e.g., CSI-ReportConfig IE(s) or new RRC IE(s) defined in 3GPP specification v18.0.0 and/or later versions). After transmitting the configuration(s) 316, the network entity 104 can transmit 312b CSI-RS(s) to the UE 102 in multiple time instances in accordance with the configuration(s) 316. After receiving the configuration(s) 316, the UE 102 receives the CSI-RS(s) 312b and performs channel estimation and/or measurement(s) based on the CSI-RS(s) 312b. The UE 102 generates ML-based CSI report(s) based on the channel estimation and/or measurement(s) and the first ML model, and transmits 324 the ML-based CSI report(s) to the network entity 104. In one implementation, the network entity 104 can indicate the first ML model in the configuration(s) 316. For example, the network entity 104 includes the first ID in the configuration(s) 316. In another implementation, the network entity 104 does not configure a ML model in the configuration(s) 316. In this case, the UE 102 determines the first ML model based on a predetermined configuration stored in the UE 102. In some implementations, the network entity 104 enables or configures ML-based CSI compression for the UE 102 in the configuration(s) 316, and the UE 102 generates compressed CSI based on the first ML model and transmits the compressed CSI in the ML-based CSI report(s) 324, as described for FIG. 2D or 2A.

In some implementations, the network entity 104 can transmit 316 RRC message(s) including the configuration(s) for ML-based CSI report(s) to the UE 102. In some implementations, the configuration(s) 316 include new CSI report configuration(s) (e.g., CSI-ReportConfig IE(s)). In other implementations, the configuration(s) 316 include configuration parameters to reconfigure at least one CSI report configuration in the configuration(s) 308 to be applied for ML-based CSI report(s). In such cases, the configuration(s) 316 includes the at least one CSI report configuration. After (e.g., in response to) applying the configuration parameters, the UE 102 stops applying the at least one CSI report configuration for non-ML-based report. After (e.g., in response to) applying the configuration parameters, the UE 102 stops transmitting non-ML-based CSI report(s) in accordance with the at least one CSI report configuration. In examples, the RRC message(s) may include RRCReconfiguration message(s). In response to each of the RRC message(s), the UE 102 can transmit a RRC response message (e.g., RRCReconfigurationComplete message) to the network entity 104. In some cases, the UE 102 is in dual connectivity with the network entity 104 (e.g., operating as a SN) and another network entity (e.g., operating as a MN not shown in FIG. 3) similar to the network entity 104. In examples, the SN 104 transmits the RRC message(s) to the UE 102 as described above. In other examples, the SN 104 transmits the RRC message(s) to the UE 102 via the MN.

In some implementations, the configuration(s) 316 includes CSI resource configuration(s) configuring the CSI-RS(s) 312b. In some implementations, the CSI-RS(s) 312b include periodic CSI-RS(s), semi-persistent CSI-RS(s) and/or aperiodic CS-RS(s). The CSI resource configuration(s) can include CSI resource configuration(s) configuring the periodic CSI-RS(s), CSI resource configuration(s) configuring semi-persistent CSI-RS(s), and/or CSI resource configuration(s) configuring aperiodic CS-RS(s). The network entity 104 can transmit 312b the periodic CSI-RS(s) on a periodic basis in accordance with the CSI resource configuration(s) configuring the periodic CSI-RS(s). The network entity 104 can transmit 312b the semi-persistent CSI-RS(s) on a semi-persistent basis in accordance with the CSI resource configuration(s) configuring the semi-persistent CSI-RS(s). The network entity 104 can transmit 312b the aperiodic CSI-RS(s) on a one-shot basis for the UE 102 to transmit aperiodic ML-based CSI report(s) in accordance with the aperiodic CSI resource configuration(s), as described below.

In some implementations, the network entity 104 may transmit the CSI-RS(s) 312b from N_{R} antenna ports, where N_{R} corresponds to a maximum number of downlink layers configured in the configuration(s) 316 or the CSI resource configuration(s). In some implementations, the network entity 104 may transmit the CSI-RS(s) or some of the CSI-RS(s) with a precoder. In other implementations, the network entity 104 may transmit the CSI-RS(s) or some of the CSI-RS(s) without a precoder.

In some implementations, the configuration(s) 316 includes semi-persistent ML-based CSI report configuration(s) configuring semi-persistent ML-based CSI report, and the UE 102 refrains from transmitting semi-persistent ML-based CSI report(s) until receiving from the network entity 104 a trigger command triggering the UE 102 to transmit semi-persistent ML-based CSI report(s) in accordance with the semi-persistent CSI report configuration(s). After transmitting the configuration(s) 316, the network entity 104 can transmit 320 to the UE 102 a trigger command triggering semi-persistent ML-based CSI report(s). After or in response to receiving the trigger command 320, the UE 102 performs channel estimation and/or measurement(s) on the CSI-RS(s) 312b, generates semi-persistent ML-based CSI report(s), and transmits 324 the semi-persistent ML-based CSI report(s) to the network entity 104. In some implementations, the UE 102 (periodically) transmits the semi-persistent ML-based CSI report(s) on PUCCH(s) that may be configured in the configuration(s) 316. In other implementations, the UE 102 (periodically) transmits the semi-persistent ML-based CSI report(s) on PUSCH(s) that may be configured in the configuration(s) 316, the semi-persistent ML-based CSI report configuration(s) and/or the trigger command. In some implementations, the trigger command is a MAC CE. In other implementations, the trigger command is a DCI. In some implementations, the CSI-RS(s) includes periodic CSI-RS(s) and/or semi-persistent CSI-RS(s). In the case of the semi-persistent CSI-RS(s), the network entity 104 can transmit an activation command to the UE 102 to indicate that the semi-persistent CSI-RS(s) is activated. After (e.g., in response to) receiving the activation command, the UE 102 determines that transmission of the semi-persistent CSI-RS(s) is activated. In some implementations, the network entity 104 transmits the activation command before or after transmitting the trigger command. Alternatively, the network entity 104 can transmit 320 a MAC PDU including the activation command and the trigger command to the UE 102. In some implementations, the activation command is a MAC CE. In some implementations, the UE 102 activates performing channel estimation and/or measurement(s) based on the CSI-RS(s) or a portion (e.g., one or some) of the CSI-RS(s) in response to receiving the trigger command. In other implementations, the UE 102 activates performing channel estimation and/or measurement(s) based on the CSI-RS(s) or a portion (e.g., one or some) of the CSI-RS(s), in response to the semi-persistent ML-based CSI report configuration(s) and before receiving the trigger command.

In other implementations, the configuration(s) 316 includes periodic ML-based CSI report configuration(s) configuring periodic ML-based CSI report(s), and the UE 102 performs channel estimation and/or measurement(s) based on the CSI-RS(s), generates ML-based CSI report(s) based on the channel estimation and/or measurement(s), and transmits the periodic ML-based CSI report(s) 324 based on or in response to the periodic ML-based CSI report configuration(s). In such cases, the UE 102 activates performing channel estimation and/or measurement(s) based on the CSI-RS(s) or a portion (e.g., one or some) of the CSI-RS(s), generates periodic ML-based CSI report(s) based on the channel estimation and/or measurement(s), and transmits 324 the periodic ML-based CSI report(s) to the network entity 104, upon receiving the periodic ML-based CSI report configuration(s). Thus, the network entity 104 does not transmit a trigger command to the UE 102 to trigger transmission of the periodic ML-based CSI report(s). In some implementations, the UE 102 transmits the periodic ML-based CSI report(s) on PUCCH(s) that may be configured in the configuration(s) 316. In other implementations, the UE 102 transmits the periodic ML-based CSI report(s) on PUSCH(s) that may be configured in the configuration(s) 316 and/or DCI(s) that the UE 102 receives from the network entity 104. The DCI(s) include UL grant(s) for the UE 102 to transmit user data and are not trigger command(s).

In yet other implementations, the configuration(s) 316 includes aperiodic ML-based CSI report configuration(s) configuring aperiodic ML-based CSI report(s). For each of the aperiodic ML-based CSI report configuration(s), the UE 102 refrains from transmitting an aperiodic ML-based CSI report until receiving from the network entity 104 a trigger command triggering the UE 102 to transmit an aperiodic ML-based CSI report in accordance with the aperiodic ML-based CSI report configuration. After transmitting the aperiodic ML-based CSI report configuration(s), the network entity 104 can transmit 320 to the UE 102 a trigger command triggering the UE 102 to transmit an aperiodic ML-based CSI report in accordance with the aperiodic ML-based CSI report configuration. In response to the trigger command, the UE 102 performs channel estimation and/or measurement(s) on the CSI-RS, generates a single aperiodic ML-based CSI report, and transmits the aperiodic ML-based CSI report, in accordance with the aperiodic ML-based CSI report configuration. In some implementations, the trigger command is a MAC CE. In other implementations, the trigger command is a DCI. In some implementations, the CSI-RS includes a periodic CSI-RS, semi-persistent CSI-RS or an aperiodic CSI-RS.

In some implementations, if the network entity 104 determines to configure the UE 102 to transmit ML-based CSI report(s), the network entity 104 may transmit 318 to the UE 102 a RRC message (e.g., RRCReconfiguration message) to release at least one CSI report configuration in the configuration(s) 308. In some implementations, if the configuration(s) 316 and configuration(s) 308 exceed the CSI report capabilities of the UE 102, the network entity 104 can transmit the RRC message 318. If the configuration(s) 316 and configuration(s) 308 does not exceed the CSI report capabilities of the UE 102, the network entity 104 may not transmit the RRC message. In some implementations, the network entity 104 may still transmit the release indication because ML-based CSI report(s) configured in the configuration(s) 316 can replace non-ML-based CSI report(s) configured in the at least one CSI report configuration.

In other implementations, if the network entity 104 determines to configure the UE 102 to transmit ML-based CSI report(s), the network entity 104 can transmit 318 to the UE 102 a RRC message (e.g., RRCReconfiguration message) to reconfigure at least one CSI report configuration in the configuration(s) 308. In some implementations, the RRC message 318 reconfigures the at least one CSI report configuration to prevent the UE 102 from transmitting non-ML-based CSI report(s) configured in the at least one CSI report configuration. For example, the at least one CSI report configuration is/are configured for periodic CSI report and the network entity 104 can reconfigure the at least one CSI report configuration for semi-persistent CSI report or aperiodic CSI report. In some implementations, if the configuration(s) 316 and configuration(s) 308 exceed the CSI report capabilities of the UE 102, the network entity 104 can transmit the RRC message. If the configuration(s) 316 and configuration(s) 308 does not exceed the CSI report capabilities of the UE 102, the network entity 104 may not transmit the RRC message. In some implementations, the network entity 104 may still transmit the RRC message because ML-based CSI report(s) configured in the configuration(s) 316 can replace the non-ML-based CSI report(s) configured in the at least one CSI report configuration.

In yet other implementations, if the network entity 104 determines to configure the UE 102 to transmit ML-based CSI report(s), the network entity 104 can transmit 318 to the UE 102 a RRC message to modify the configuration(s) 308. In some implementations, the RRC message modifies the configuration(s) 308 so that the UE 102 transmits non-ML-based CSI report(s) less frequently. The network entity 104 can do so because the network entity 104 can use ML-based CSI report(s) configured in the configuration(s) 316 instead of most non-ML-based CSI report(s) configured in the configuration(s) 308.

The events 312b, 316, 318, 320, and 324 are collectively referred to in FIG. 3A as an ML-based CSI reporting procedure 392.

In some implementations, the procedure 390 can completely or partially overlap with the procedure 392. In other implementations, the procedure 390 does not overlap with the procedure 392. In some implementations, the configuration(s) 308 and configuration(s) 316 include at least one identical configuration. For example, the CSI-RS(s) 312a and CSI-RS(s) 312b can include identical CSI-RS(s) and/or different CSI-RS(s). To configure the UE 102 to generate ML-based CSI report(s) and a non-ML-based CSI report(s) based on the identical CSI-RS(s), the network entity 104 can transmit CSI resource configuration(s) (i.e., single instance(s)) each including a CSI resource configuration ID and configuring CSI-RS(s), and include the CSI resource configuration ID in the configuration(s) 308 and configuration(s) 316. The UE 102 identifies the CSI resource configuration(s) based on the (same) CSI resource configuration ID. Thus, the UE 102 receives the CSI-RS(s) configured in the CSI resource configuration(s), performs channel estimation and/or measurement(s) on the CSI-RS(s), and transmits ML-based CSI report(s) and non-ML-based CSI report(s) based on the channel estimation and/or measurement(s). For each of the ML-based CSI report(s), the network entity 104 can obtain ML-based CSI (e.g., compressed CSI) from the ML-based CSI report and obtain reconstructed CSI (e.g., decompressed CSI) from the ML-based CSI and first ML model (e.g., the neural network for decompression 270b). For each of the non-ML-based CSI report(s), the network entity 104 also retrieves non-ML based CSI from the non-ML-based CSI report.

In some implementations, the network entity 104 can determine 326 to perform ML model performance monitoring and/or evaluation for the first ML model after or in response to transmitting the configuration(s) 316 to the UE 102. In other implementations, the network entity 104 can determine whether to perform the ML model performance monitoring and/or evaluation based on one or more system performance metrics, such as system throughput, BLER, a maximum number of HARQ retransmissions, RSRP, RSRQ, and/or SINR) as described for FIG. 2F. In some implementations, the network entity 104 performs the non-ML-based CSI reporting procedure 390 with the UE 102 in response to the determination. In response to determining to perform the ML model performance monitoring and/or evaluation, the network entity 104 evaluates or determines 340a performance of the first ML model based on the reconstructed CSI and the non-ML based CSI for the same instance of the CSI-RS. In the performance monitoring and/or evaluation 340a, the network entity 104 determines an AI/ML model performance metric based on the non-ML-based CSI and the reconstructed CSI and evaluates the performance metric against a performance metric threshold.

For example, if the performance metric is above or equal to the performance metric threshold, the network entity 104 determines that performance of the first ML model (e.g., the neural network for CSI compression 270a) is good. Otherwise, if the performance metric is below the performance metric threshold, the network entity 104 determines that performance of the first ML model is bad. In response to determining that performance of the first ML model is bad, the network entity 104 transmits 342 a command to the UE 102 to release or deactivate the configuration(s) 316 (e.g., configure the UE 102 to stop using the first ML model or deactivate the first ML model) or replace the first ML model with a second ML model. The UE 102 releases or deactivate the configuration(s) or replaces the first ML model with the second ML model, in response to the command 342. The command can be a message (e.g., RRCReconfiguration message), a MAC CE or a DCI. For example, the network entity 104 can include configuration ID(s) of the configuration(s) 316 in a release information element (IE) in the message to configure the UE 102 to release the configuration(s) 316. In another example, the network entity 104 can include configuration ID(s) of the configuration(s) 316 in the MAC CE or DCI to configure the UE 102 to deactivate the configuration(s) 316. In the case of replacing the first ML model with the second ML model, the network entity 104 can include a second ID of the second ML model in the command. In some implementations, the CSI report capabilities, container IE or UE capability information indicates support of the second ML model or includes the second ID. The network entity 104 may transmit the command 342 to replace the first ML model with the second ML model because the network entity 104 determines that the UE 102 supports the second ML model based on the CSI report capabilities, container IE or UE capability information. If the UE 102 does not support the second ML model, the network entity 104 may transmit the command 342 to release or deactivate the configuration(s) 316.

In the case of the replacing the first ML model with the second ML mode, the UE 102 transmits ML-based CSI report(s) to the network entity 104, similar to the event 324.

FIG. 3B is a signaling diagram 315 that illustrates an example of ML model performance monitoring and reporting. Elements 302, 304, 306, 342, 390, and 392 have already been described with respect to FIG. 3A.

After or during the ML-based CSI reporting procedure 392, the network entity 104 determines 325 to configure the UE 102 to perform ML model performance reporting. In some implementations, the UE capability information, container IE, or CSI report capabilities include a capability indicating that the UE 102 supports ML model performance reporting, monitoring, and/or evaluation. The network entity 104 can make the determination 325 based on the capability indicating support of ML model performance reporting, which includes support of ML model performance monitoring and/or evaluation.

Based on the determination 325, the network entity 104 transmits 328 a configuration of ML model performance reporting to the UE 102. In response to the configuration 328, the UE 102 activates 330 ML model performance monitoring and/or evaluation. In some implementations, the network entity 104 can include at least one ID each identifying an ML model in the configuration 328, the UE 102 activates 330 the ML model performance monitoring and/or evaluation for/with the ML model(s) identified by the at least one ID. For example, the ML model(s) include the first ML model and the at least one ID includes the first ID. Thus, the UE 102 activates the ML model performance monitoring and/or evaluation for/with the first ML model in the event 330. In another example, the ML model(s) include the second ML model and the at least one ID includes the second ID. Thus, the UE 102 activates the ML model performance monitoring and/or evaluation for/with the second ML model in the event 330. In other implementations, the network entity 104 does not include an ID of an ML model in the configuration 328, the UE 102 activates the ML model performance monitoring and/or evaluation for/with an ML model that the UE 102 is using for the ML-based CSI report(s) 334 or in the ML-based CSI reporting procedure 392. i.e., the first ML model.

After receiving the configuration 328, the UE 102 may receive 331 a trigger command and/or 332 CSI-RS(s) from the network entity 104, similar to the events 310, 320, and/or 312, respectively. Afterwards, the UE 102 generates non-ML-based CSI report(s) and/or ML-based CSI report(s) based on channel estimation and/or measurement(s) of the CSI-RS(s) 332, and transmits 334 the non-ML-based CSI report(s) and/or ML-based CSI report(s) to the network entity 104, similar to the events 314 and/or 324. The UE 102 uses the first ML model to generate the ML-based CSI report(s) 334, similar to the event 324.

After (e.g., in response to) activating the ML model performance monitoring and/or evaluation for the ML model, the UE 102 performs ML model performance monitoring and/or evaluation based on the CSI-RS(s) 332. The UE 102 generates ML model performance report(s) based on result(s) from the ML model performance monitoring and/or evaluation, and transmits 336 the ML model performance report(s) to the network entity 104. In some implementations, the UE 102 includes the at least one ID in the ML model performance report(s). Thus, the network entity 104 determines the ML model performance report(s) for (e.g., associated with) the ML model(s) based on the at least one ID. In other implementations, the UE 102 does not include an ID of an ML model in the ML model performance report(s), and the network entity 104 determines the ML model performance report(s) for (e.g., associated with) an ML model that the UE 102 is using for the ML-based CSI report(s) 334 or in the ML-based CSI reporting procedure 392. The network entity 104 determines 340b ML model performance based on the ML model performance report(s) 336. Based on the determined ML model performance, the network entity 104 can transmit 342 the command to the UE 102 to release or deactivate the configuration(s) 316 or replace the first ML model with the second ML model, as described for FIG. 3A. For example, if the network entity 104 determines that performance of the first ML model is not good and/or the second ML model is good or better than the first ML model based on the ML model performance report(s), the network entity 104 transmits 342 the command to the UE 102 to release or deactivate the configuration(s) 316 or replace the first ML model with the second ML model, as described for FIG. 3A.

In some implementations, based on (each of) the CSI-RS(s) 332, the UE 102 generates a performance metric from the ML model performance monitoring and/or evaluation. In some implementations, the configuration 328 configures the UE 102 to periodically transmit an ML model performance report, and the UE 102 periodically transmits an ML model performance report including a performance metric to the network entity 104 in the event 336.

In other implementations, the configuration 328 configures an event-triggered ML model performance reporting. For example, the configuration 328 includes a performance metric threshold for the UE 102 to determine whether a reporting event occurs. In one implementation, if the performance metric is below the performance metric threshold (e.g., a reporting event occurs), the UE 102 transmits an ML model performance report to the network entity 104 in the event 336. The UE 102 can include, in the ML model performance report, a performance metric, and/or an indication indicating that the performance metric is below the performance metric threshold. Otherwise, if the performance metric is above or equal to the performance metric threshold, the UE 102 refrains from transmitting an ML model performance report to the network entity 104. In another implementation, if the performance metric is above or equal to the performance metric threshold (e.g., a reporting event occurs), the UE 102 transmits an ML model performance report to the network entity 104 in the event 336. The UE 102 can include, in the ML model performance report, a performance metric and/or an indication indicating that the performance metric is above or equal to the performance metric threshold. Otherwise, if the performance metric is below the performance metric threshold, the UE 102 refrains from transmitting an ML model performance report to the network entity 104. In some scenarios or implementations, the configuration 328 does not include a performance metric threshold, and the UE 102 pre-determines or pre-stores the performance metric threshold predefined in a 3GPP specification. In some implementations, the UE 102 periodically transmits an ML model performance report to the network entity 104 in the event 336 after detecting occurrence of the event. The network entity 104 can configure the UE 102 to do so in the configuration 328. In other implementations, the UE 102 transmits N ML model performance reports to the network entity 104 in the event 336 after detecting occurrence of the event. Nis an integer and larger than zero. The network entity 104 can configure N in the configuration 328.

In some implementations, the network entity 104 can include CSI resource configuration(s) configuring the CSI-RS(s) 332 in the configuration 328. The UE 102 uses the CSI resource configuration(s) to receive the CSI-RS(s) 332. In other implementations, the network entity 104 does not include CSI resource configuration(s) in the configuration 328. In such cases, the CSI-RS(s) 332 are configured in the configuration(s) 308 and/or the configuration(s) 316, and the UE 102 receives the CSI-RS(s) 332 as described for the event 312.

FIG. 3C is a signaling diagram 335 that illustrates an example of ML model performance monitoring and reporting. Elements 302, 304, 306, 342, 390, and 392 have already been described with respect to FIG. 3A. Elements 325, 328, 330, 332, 336, and 340b have already been described with respect to FIG. 3B.

In the signaling diagram 335, the network entity 104 determines 337c to configure the UE 102 to perform ML-based CSI reporting based on the ML model performance report(s). Based on the determination 337c, the network entity 104 performs the ML-based CSI reporting procedure 392 with the UE 102. For example, if the network entity 104 determines that performance of the first ML model is good (i.e., the first ML model is suitable for communication with between the UE 102 and network entity 104) based on the ML model performance report(s), the network entity 104 performs the ML-based CSI reporting procedure 392 with the UE 102. Otherwise, if the network entity 104 determines that performance of the first ML model is not good (i.e., the first ML model is not suitable for communication with between the UE 102 and network entity 104), the network entity 104 refrains from configuring the UE 102 to perform ML-based CSI reporting.

FIG. 3D is a signaling diagram 345 that illustrates an example of ML model performance monitoring based on SRS(s). Elements 302, 304, 306, 326, 342, 390, and 392 have already been described with respect to FIG. 3A.

Before, after, or in response to the determination 326, the network entity 104 transmits 344 an SRS configuration (e.g., SRS-Config) to the UE 102 to configure the UE 102 to transmit 346 SRS(s). In some implementations, the network entity transmits a message (e.g., RRCReconfiguration message) including the SRS configuration to the UE 102. In response, the UE 102 transmits a response message (e.g., RRCReconfigurationComplete message) to the network entity 104. The UE 102 transmits 346 the SRS(s) to the network entity 104 in accordance with the SRS configuration, during or after the procedure 392. The network entity 104 determines 340d ML model performance for at least one ML model, based on the SRS(s). In some implementations, the at least one ML model includes the first ML model and/or second ML model. Based on the determined ML model performance, the network entity 104 can transmit 342 the command to the UE 102 to release or deactivate the configuration(s) 316 or replace the first ML model with the second ML model, as described for FIG. 3A.

In some implementations, the network entity 104 performs ML model performance monitoring and/or evaluation based on the SRS(s). The network entity 104 determines or generates a performance metric for each of the at least one ML model. The network entity 104 determines performance of the each of at least one ML model based on the corresponding performance metric and the (same) performance metric threshold in the event 340c. For example, if the performance metric for the first ML model is below the performance metric threshold, the network entity 104 transmits the command 342 to the UE 102 to release or deactivate the configuration(s) 316. In another example, if the performance metric for the first ML model is below the performance metric threshold and the performance metric for the second ML model is above the performance metric threshold, the network entity 104 transmits the command 342 to replace the first ML model with the second ML model.

FIG. 3E is a signaling diagram 355 that illustrates an example of ML model performance monitoring based on SRS(s). Elements 302, 304, 306, 326, 342, 390, and 392 have already been described with respect to FIG. 3A. Elements 340d, 344, and 346 have already been described with respect to FIG. 3D.

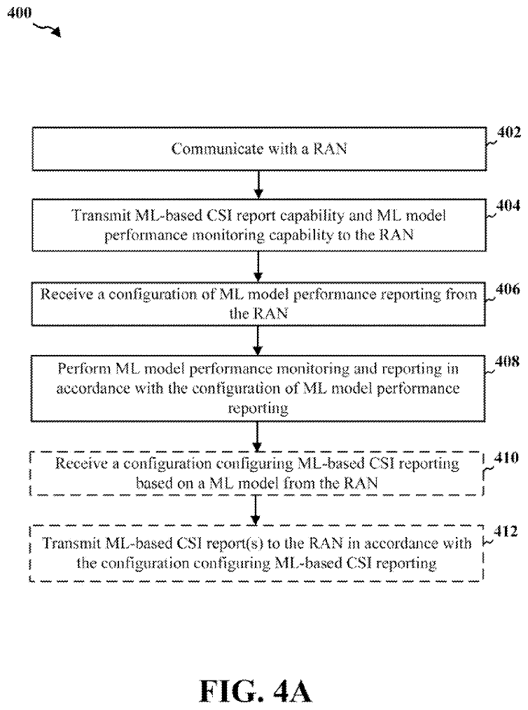

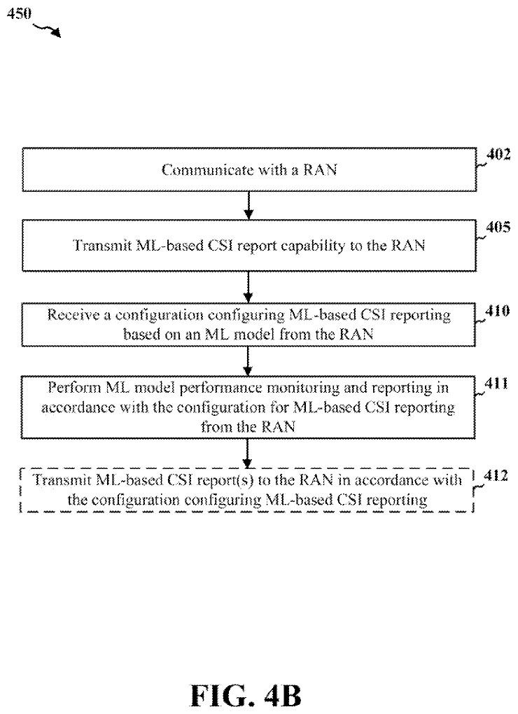

In the signaling diagram 355, the network entity 104 transmits 344 the SRS configuration to the UE 102 before performing the ML-based CSI reporting procedure 392 with the UE 102. The network entity 104 determines 337e to configure the UE 102 to perform ML-based CSI reporting based on the SRS(s) 346. Based on the determination 337e, the network entity 104 performs the ML-based CSI reporting procedure 392 with the UE 102. For example, if the network entity 104 determines that performance of the first ML model is good (i.e., suitable for communication with between the UE 102 and network entity 104) based on the SRS(s), the network entity 104 performs the ML-based CSI reporting procedure 392 with the UE 102. Otherwise, if the network entity 104 determines that performance of the first ML model is not good (i.e., the first ML model is not suitable for communication with between the UE 102 and network entity 104), the network entity 104 refrains from configuring the UE 102 to perform ML-based CSI reporting. FIGS. 3A-3E illustrate example procedures for ML model performance monitoring. FIGS. 4A-9 show methods for implementing one or more aspects of FIGS. 3A-3E.

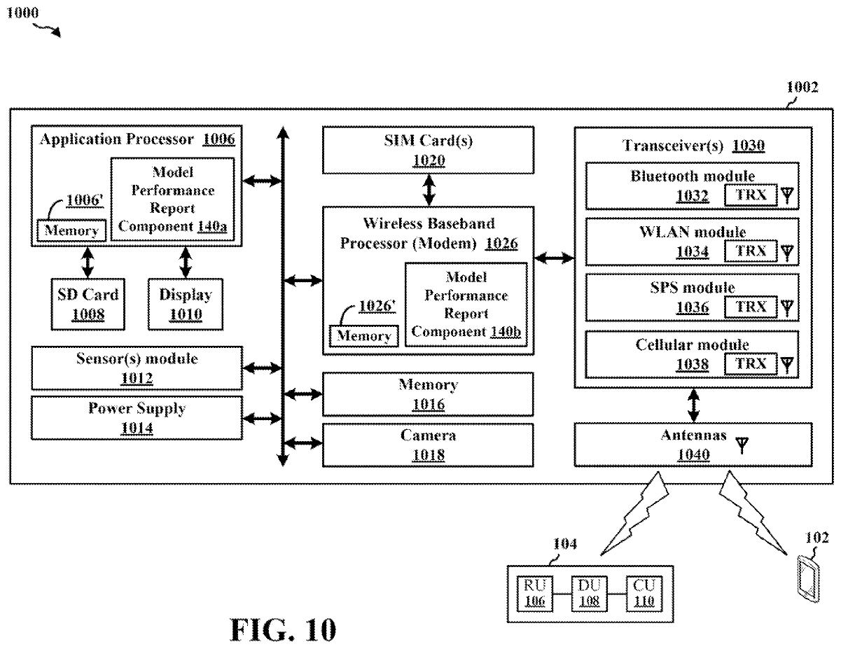

FIGS. 4A-4B illustrate flowcharts 400, 450 of a method of wireless communication at a UE. With reference to FIGS. 3A-3E and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006. The UE 102 can implement the flowcharts 400, 450 for managing ML-based CSI reporting with a RAN (e.g., the network entity 104).

Referring to the flowchart 400, the UE 102 communicates 402 with a RAN. For example, in FIGS. 3A-3E, the UE 102 communicates with the network entity 104. The UE 102 transmits 404 an ML-based CSI report capability and an ML model performance monitoring capability to the RAN. For example, in FIGS. 3A-3E, the UE 102 transmits 304 UE capability information (e.g., CSI report capabilities) to the network entity 104. The UE 102 receives 406 a configuration for ML model performance reporting from the RAN. For example, in FIGS. 3B-3C, the UE 102 receives 328, from the network entity 104, a configuration of ML model performance reporting. The UE 102 performs 408 the ML model performance monitoring and reporting in accordance with the configuration of ML model performance reporting. For example, in FIGS. 3B-3C, the UE 102 activates 330 ML model performance monitoring and/or evaluation and transmits 336 ML model performance report(s) to the network entity 104. The UE 102 receives 410 a configuration configuring ML-based CSI reporting based on a ML model from the RAN. For example, in FIG. 3A, the UE 102 receives 316 an ML-based CSI report configuration for the ML-based CSI reporting procedure 392. The UE 102 transmits 412 ML-based CSI report(s) to the RAN in accordance with the configuration configuring ML-based CSI reporting. For example, in FIG. 3A, the UE 102 transmits 324 an ML-based CSI report to the network entity 104 based on the ML-based CSI report configuration received 316 from the network entity 104.

Referring to the flowchart 450, elements 402, 410, and 412 have already been described with respect to FIG. 4A. The UE 102 transmits 405 an ML-based CSI report capability to the RAN. For example, in FIGS. 3A-3E, the UE 102 transmits 304 UE capability information (e.g., CSI report capabilities) to the network entity 104. The UE 102 performs 411 ML model performance monitoring and reporting in accordance with the configuration for ML-based CSI reporting from the RAN. For example, in FIGS. 3B-3C, the UE 102 activates 330 ML model performance monitoring and/or evaluation and transmits 336 ML model performance report(s) to the network entity 104.

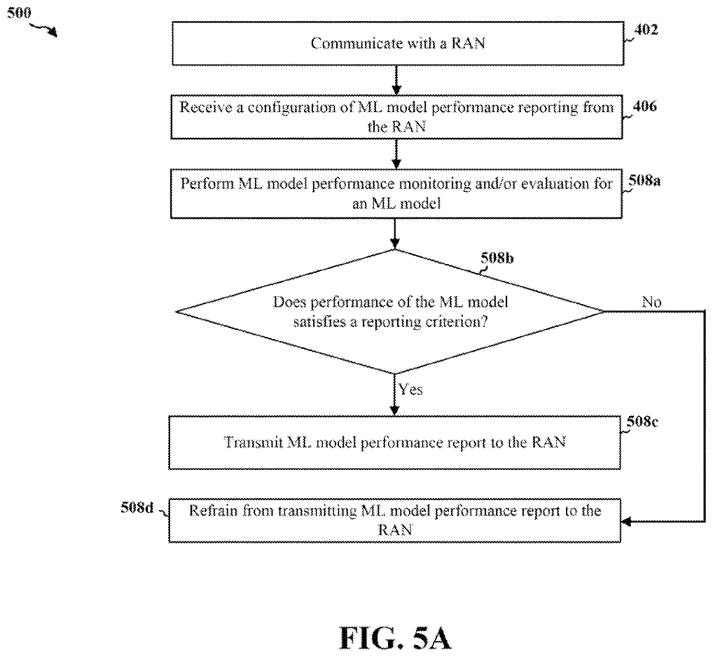

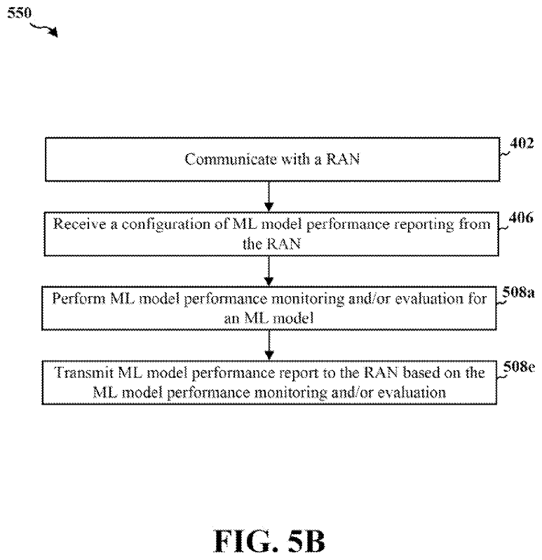

FIGS. 5A-5B illustrate flowcharts 500, 550 of a method of wireless communication at a UE. With reference to FIGS. 3A-3E and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006. The UE 102 can implement the flowcharts 500, 550 for transmitting an ML model performance report to a RAN (e.g., the network entity 104).

Referring to the flowchart 500, elements 402 and 406 have already been described with respect to FIG. 4A. The UE 102 performs 508a ML model performance monitoring and/or evaluation for an ML model. For example, in FIGS. 3B-3C, the UE 102 activates 330 ML model performance monitoring and/or evaluation and transmits 336 ML model performance report(s) to the network entity 104. The UE 102 determines 508b whether the performance of the ML model satisfies a reporting criterion. If the UE 102 determines 508b that performance of the ML model satisfies the reporting criterion, the UE 102 transmits an ML model performance report to the RAN. For example, in FIGS. 3B-3C, the UE 102 transmits 336 ML model performance report(s) to the network entity 104. Otherwise, if the UE 102 determines 508b that the performance of the ML model does not satisfy the reporting criterion, the UE 102 refrains 508d from transmitting the ML model performance report to the RAN.

Referring to the flowchart 550, elements 402 and 406 have already been described with respect to FIG. 4A. Element 508a has already been described with respect to FIG. 5A. The UE 102 transmits 508e an ML model performance report to the RAN based on the ML model performance monitoring and/or evaluation. For example, in FIGS. 3B-3C, the UE 102 transmits 336 ML model performance report(s) to the network entity 104.

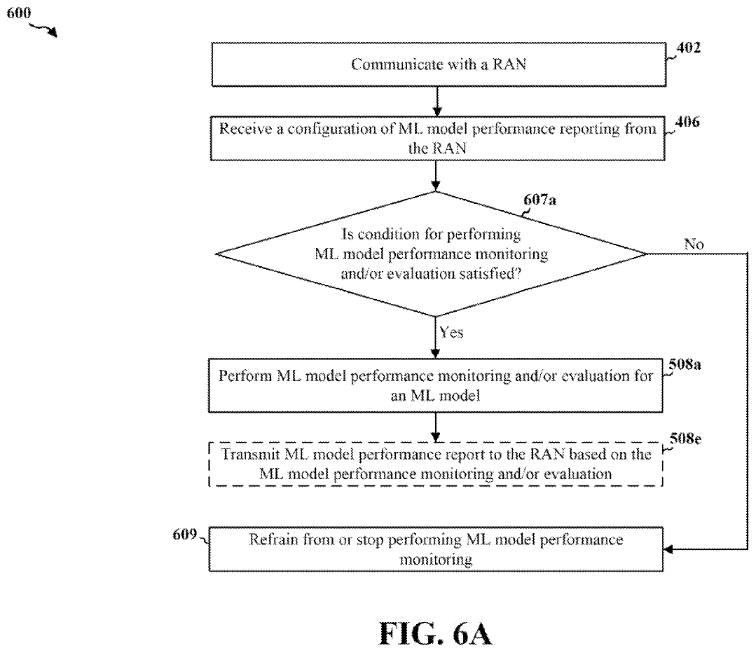

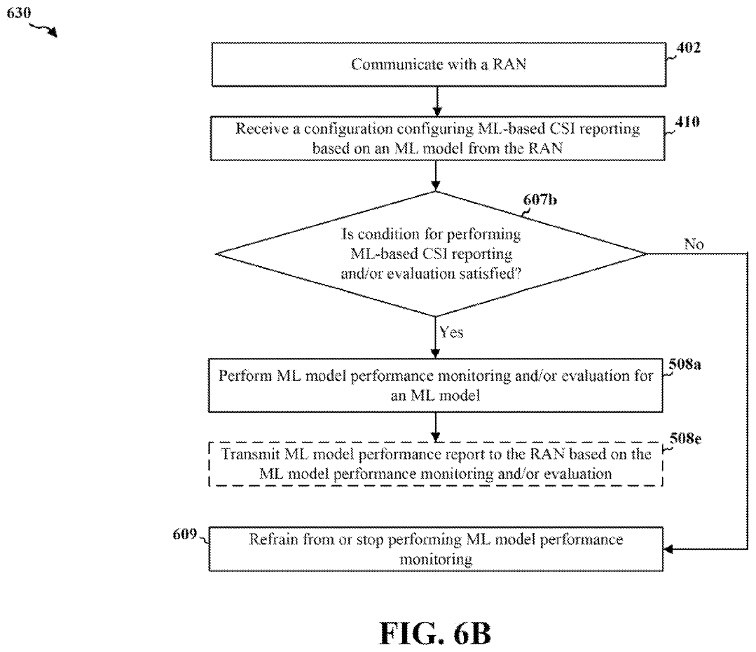

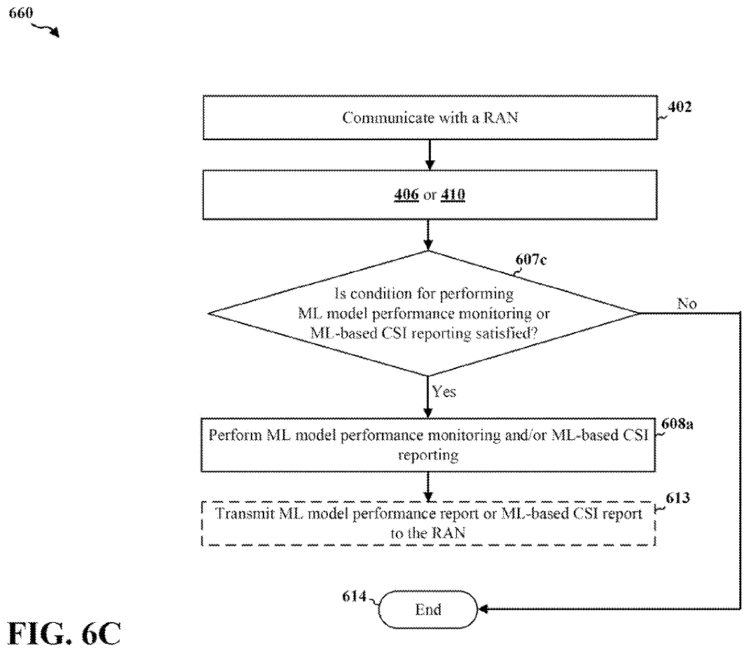

FIGS. 6A-6C illustrate flowcharts 600, 630, 660 of a method of wireless communication at a UE. With reference to FIGS. 3A-3E and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006. The UE 102 can implement the flowcharts 600, 630, 660 for performing ML model performance monitoring and/or evaluation.

Referring to the flowchart 600, elements 402 and 406 have already been described with respect to FIG. 4A. Element 508a has already been described with respect to FIG. 5A. Element 508e has already been described with respect to FIG. 5B. The UE 102 determines 607a whether a condition for performing ML model performance monitoring and/or evaluation is satisfied. In some implementations, the UE 102 determines 607a whether the condition for performing ML model performance monitoring and/or evaluation is satisfied, only if the UE 102 receives 406 the configuration for the ML model performance reporting from the RAN. If the UE 102 determines 607a that the condition for performing the ML model performance monitoring and/or evaluation is satisfied, the UE 102 performs 508a ML model performance monitoring and/or evaluation for the ML model and may transmit 508e the ML model performance report to the RAN based on the ML model performance monitoring. Otherwise, if the UE 102 determines 607a that the condition for performing the ML model performance monitoring and/or evaluation is not satisfied, the UE 102 refrains from or stops 609 performing ML model performance monitoring.

Referring to the flowchart 630, elements 402 and 410 have already been described with respect to FIG. 4A. Element 508a has already been described with respect to FIG. 5A. Element 508e has already been described with respect to FIG. 5B. Element 609 has already been described with respect to FIG. 6A. The UE 102 determines 607b whether a condition for performing ML-based CSI reporting and/or evaluation is satisfied. In some implementations, the UE 102 determines 607b whether the condition for performing ML-based CSI reporting and/or evaluation is satisfied, only if the UE 102 receives 410 the configuration configuring ML-based CSI reporting based on an ML model from the RAN.

If the UE 102 determines 607b that the condition for performing the ML-based CSI reporting and/or evaluation is satisfied, the UE 102 performs 508a ML model performance monitoring and/or evaluation for the ML model and may transmit 508e the ML model performance report to the RAN based on the ML model performance monitoring. Otherwise, if the UE 102 determines 607b that the condition for performing the ML-based CSI reporting and/or evaluation is not satisfied, the UE 102 refrains from or stops 609 performing ML model performance monitoring.

Referring to the flowchart 660, elements 402, 406, and 410 have already been described with respect to FIG. 4A. The UE 102 determines 607c whether a condition for performing ML model performance monitoring or ML-based CSI reporting is satisfied. If the UE 102 determines 607c that a condition is satisfied, the UE 102 performs 608a ML model performance monitoring and/or ML-based CSI reporting and may transmit 613 the ML model performance report or the ML-based CSI report to the RAN. Otherwise, if the UE 102 determines 607c that a condition is not satisfied, the UE 102 ends 614 the method of flowchart 660.

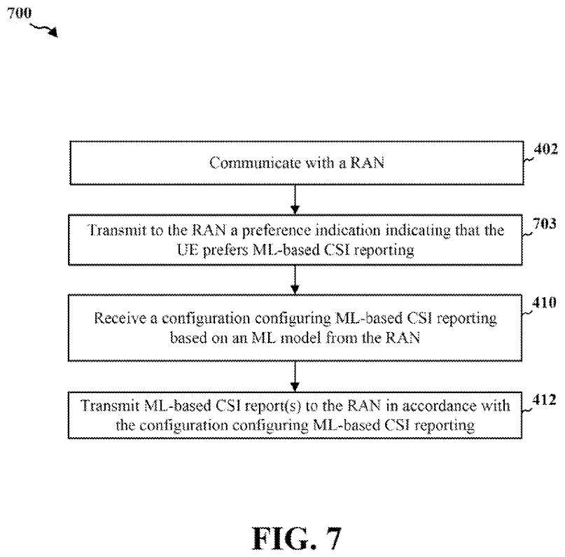

FIG. 7 illustrates a flowchart 700 of a method of wireless communication at a UE. With reference to FIGS. 3A-3E and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006. The UE 102 can implement the flowchart 700 for ML-based CSI reporting to a RAN (e.g., the network entity 104).

Referring to the flowchart 700, elements 402, 410, and 412 have already been described with respect to FIG. 4A. The UE 102 transmits 703 to the RAN a preference indication indicating that the UE 102 prefers ML-based CSI reporting (e.g., over non-ML-based CSI reporting). In some implementations, the preference indication includes an ID of the first ML model in the preference indication. The RAN determines to configure or configures the first ML model based on the ID. In some implementations, the preference indication is an RRC message, a MAC-CE, or UL control information (UCI) transmitted on a PUCCH. The RRC message can be a UEAssistanceInformation message or a different RRC message, e.g., defined in 3GPP specifications. In some implementations, the UE 102 receives, from the RAN, an RRC message (e.g., RRCReconfiguration message or an RRCResume message) including a preference indication configuration allowing or configuring the UE 102 to transmit the preference indication. If the UE 102 does not receive the preference indication configuration, the UE 102 refrains from transmitting the preference indication to the RAN. In some implementations, the UE 102 activates and/or performs ML performance monitoring and/or evaluation in response to receiving the preference indication configuration. Thus, the UE 102 can determine whether the UE 102 prefers ML-based CSI reporting (e.g., with the first ML model) based on the ML performance monitoring and/or evaluation. If the UE 102 does not receive the preference indication configuration, the UE 102 may refrain from activating and/or performing ML performance monitoring and/or evaluation. In other implementations, the UE 102 activates and/or performs ML performance monitoring and/or evaluation (e.g., with the first ML model) in response to receiving configuration(s) for non-ML-based CSI report(s) (e.g., event 308). If the UE 102 does not receive configuration(s) for non-ML-based CSI report(s), the UE 102 may refrain from activating and/or performing ML performance monitoring and/or evaluation.

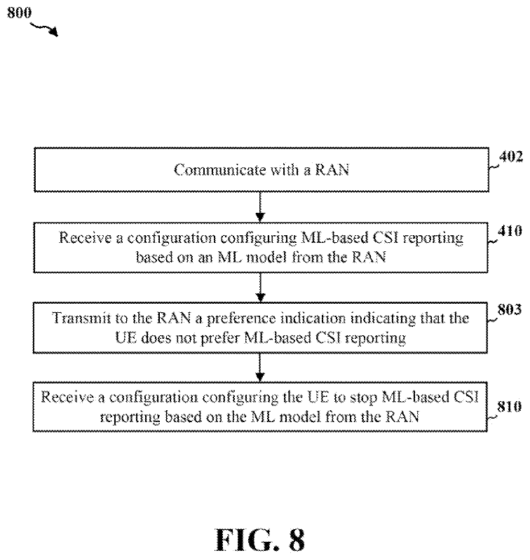

FIG. 8 illustrates a flowchart 800 of a method of wireless communication at a UE. With reference to FIGS. 3A-3E and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006. The UE 102 can implement the flowchart 800 for stopping ML-based CSI reporting to a RAN (e.g., the network entity 104).

Referring to the flowchart 800, elements 402 and 410 have already been described with respect to FIG. 4A. The UE 102 transmits 803 to the RAN a preference indication indicating that the UE 102 does not prefer ML-based CSI reporting. The UE 102 receives 810 a configuration configuring the UE 102 to stop (e.g., release or deactivate) ML-based CSI reporting based on the ML model from the RAN (e.g., event 342). In some implementations, the configuration 410 configures the UE 102 to use a first ML model to perform the ML-based CSI reporting. In some implementations, the preference indication includes an ID of the first ML model in the preference indication. The configuration 810 can include the ID to indicate the UE 102 to stop using the first ML model for ML-based CSI reporting. Examples and implementations described with respect to FIG. 7 can also apply to FIG. 8.

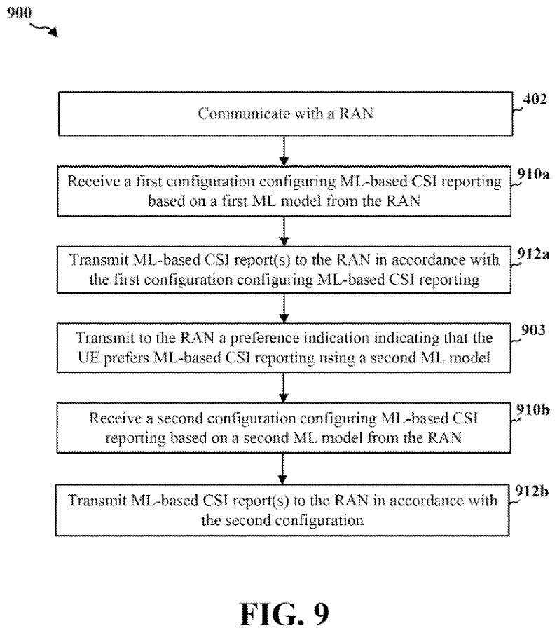

FIG. 9 illustrates a flowchart 900 of a method of wireless communication at a UE. With reference to FIGS. 3A-3E and 10, the method may be performed by the UE 102, the UE apparatus 1002, etc., which may include the memory 1026′, 1006′, 1016, and which may correspond to the entire UE 102 or the entire UE apparatus 1002, or a component of the UE 102 or the UE apparatus 1002, such as the wireless baseband processor 1026 and/or the application processor 1006. The UE 102 can implement the flowchart 900 for reconfiguring an ML model for ML-based CSI reporting to a RAN (e.g., the network entity 104).

Referring to the flowchart 900, element 402 has already been described with respect to FIG. 4A. The UE 102 receives 910a a first configuration configuring ML-based CSI reporting based on a first ML model from the RAN. For example, in FIG. 3A, the UE 102 receives 316 an ML-based CSI report configuration for the ML-based CSI reporting procedure 392. The UE 102 transmits 912a ML-based CSI report(s) to the RAN in accordance with the first configuration configuring the ML-based CSI reporting. For example, in FIG. 3A, the UE 102 transmits 324 an ML-based CSI report for the ML-based CSI reporting procedure 392. The UE 102 can transmit 903 to the RAN a preference indication indicating that the UE 102 prefers ML-based CSI reporting using a second ML model. The UE 102 receives 910b a second configuration configuring ML-based CSI reporting based on a second ML model from the RAN. The UE 102 transmits 912b ML-based CSI report(s) to the RAN in accordance with the second configuration.

In some implementations, the preference indication includes an ID of the second ML model in the preference indication. The RAN determines to configure or configures the second ML model based on the ID. Examples and implementations described for FIG. 7 can also apply to FIG. 9. In some implementations, the UE 102 activates and/or performs ML performance monitoring and/or evaluation in response to receiving the preference indication configuration. Thus, the UE 102 can determine whether the UE 102 prefers ML-based CSI reporting (e.g., with the first ML model and/or second ML model) based on the ML performance monitoring and/or evaluation. If the UE 102 does not receive the preference indication configuration, the UE 102 may refrain from activating and/or performing ML performance monitoring and/or evaluation. In other implementations, the UE 102 activates and/or performs ML performance monitoring and/or evaluation (e.g., with the first ML model and/or second ML model) in response to receiving configuration(s) for non-ML-based CSI report(s) (e.g., event 308) and/or ML-based CSI report(s) (e.g., event 316). If the UE 102 does not receive configuration(s) for non-ML-based CSI report(s), the UE 102 may refrain from activating and/or performing ML performance monitoring and/or evaluation.

In some implementations, the UE 102 indicates an ID in the preference indication (first preference indication). For example, the UE 102 includes a first ID (e.g., ML model ID) identifying the first ML model in the first preference indication. While the UE 102 performs ML-based CSI reporting in accordance with the configuration (e.g., first configuration), the UE 102 can transmit to the RAN a second preference indication indicating that the UE 102 prefers ML-based CSI reporting with a second ML model. For example, the UE 102 includes a second ID (e.g., ML model ID) identifying the second ML model in the second preference indication. After transmitting the second preference indication, the UE 102 receives from the RAN a configuration configuring the UE 102 to perform ML-based CSI reporting using the second ML model instead of the first ML model.

FIG. 10 is a diagram 1000 illustrating an example of a hardware implementation for a UE apparatus 1002. The UE apparatus 1002 may be the UE 102, a component of the UE 102, or may implement UE functionality. The UE apparatus 1002 may include an application processor 1006, which may have on-chip memory 1006′. In examples, the application processor 1006 may be coupled to a secure digital (SD) card 1008 and/or a display 1010. The application processor 1006 may also be coupled to a sensor(s) module 1012, a power supply 1014, an additional module of memory 1016, a camera 1018, and/or other related components. For example, the sensor(s) module 1012 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1002 may further include a wireless baseband processor 1026, which may be referred to as a modem. The wireless baseband processor 1026 may have on-chip memory 1026′. Along with, and similar to, the application processor 1006, the wireless baseband processor 1026 may also be coupled to the sensor(s) module 1012, the power supply 1014, the additional module of memory 1016, the camera 1018, and/or other related components. The wireless baseband processor 1026 may be additionally coupled to one or more subscriber identity module (SIM) card(s) 1020 and/or one or more transceivers 1030 (e.g., wireless RF transceivers).

Within the one or more transceivers 1030, the UE apparatus 1002 may include a Bluetooth module 1032, a WLAN module 1034, an SPS module 1036 (e.g., GNSS module), and/or a cellular module 1038. The Bluetooth module 1032, the WLAN module 1034, the SPS module 1036, and the cellular module 1038 may each include an on-chip transceiver (TRX), or in some cases, just a transmitter (TX) or just a receiver (RX). The Bluetooth module 1032, the WLAN module 1034, the SPS module 1036, and the cellular module 1038 may each include dedicated antennas and/or utilize antennas 1040 for communication with one or more other nodes. For example, the UE apparatus 1002 can communicate through the transceiver(s) 1030 via the antennas 1040 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1026 and the application processor 1006 may each include a computer-readable medium/memory 1026′. 1006′, respectively. The additional module of memory 1016 may also be considered a computer-readable medium/memory. Each computer-readable medium/memory 1026′, 1006′, 1016 may be non-transitory. The wireless baseband processor 1026 and the application processor 1006 may each be responsible for general processing, including execution of software stored on the computer-readable medium/memory 1026′, 1006′, 1016. The software, when executed by the wireless baseband processor 1026/application processor 1006, causes the wireless baseband processor 1026/application processor 1006 to perform the various functions described herein. The computer-readable medium/memory may also be used for storing data that is manipulated by the wireless baseband processor 1026/application processor 1006 when executing the software. The wireless baseband processor 1026/application processor 1006 may be a component of the UE 102. The UE apparatus 1002 may be a processor chip (e.g., modem and/or application) and include just the wireless baseband processor 1026 and/or the application processor 1006. In other examples, the UE apparatus 1002 may be the entire UE 102 and include the additional modules of the apparatus 1002.

As discussed in FIG. 1 and implemented with respect to FIGS. 4A-10, the model performance report component 140 is configured to receive an ML model performance report configuration from a network entity; and transmit, to the network entity, an ML model performance report prepared according to the ML model performance report configuration, the ML model performance report conveying a performance of a current ML model used to compress CSI, the performance being based on a comparison of the CSI with a decompressed output of the current ML model. The model performance report component 140 may be within the application processor 1006 (e.g., at 140a), the wireless baseband processor 1026 (e.g., at 140b), or both the application processor 1006 and the wireless baseband processor 1026. The model performance report component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

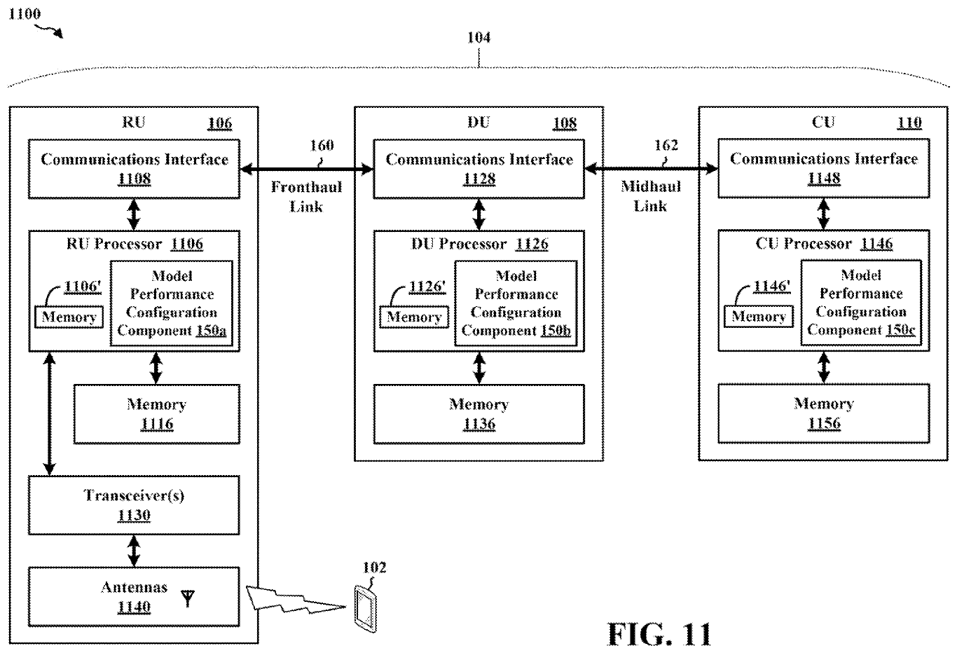

FIG. 11 is a diagram 1100 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1146, which may have on-chip memory 1146′. In some aspects, the CU 110 may further include an additional module of memory 1156 and/or a communications interface 1148, both of which may be coupled to the CU processor 1146. The CU 110 can communicate with the DU 108 through a midhaul link 162, such as an F1 interface between the communications interface 1148 of the CU 110 and a communications interface 1128 of the DU 108.

The DU 108 may include a DU processor 1126, which may have on-chip memory 1126′. In some aspects, the DU 108 may further include an additional module of memory 1136 and/or the communications interface 1128, both of which may be coupled to the DU processor 1126. The DU 108 can communicate with the RU 106 through a fronthaul link 160 between the communications interface 1128 of the DU 108 and a communications interface 1108 of the RU 106.

The RU 106 may include an RU processor 1106, which may have on-chip memory 1106′. In some aspects, the RU 106 may further include an additional module of memory 1116, the communications interface 1108, and one or more transceivers 1130, all of which may be coupled to the RU processor 1106. The RU 106 may further include antennas 1140, which may be coupled to the one or more transceivers 1130, such that the RU 106 can communicate through the one or more transceivers 1130 via the antennas 1140 with the UE 102.

The on-chip memory 1106′, 1126′, 1146′ and the additional modules of memory 1116, 1136, 1156 may each be considered a computer-readable medium/memory. Each computer-readable medium/memory may be non-transitory. Each of the processors 1106, 1126, 1146 is responsible for general processing, including execution of software stored on the computer-readable medium/memory. The software, when executed by the corresponding processor(s) 1106, 1126, 1146 causes the processor(s) 1106, 1126, 1146 to perform the various functions described herein. The computer-readable medium/memory may also be used for storing data that is manipulated by the processor(s) 1106, 1126, 1146 when executing the software. In examples, the model performance configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1, the model performance configuration component 150 is configured to transmit an ML model performance report configuration to a UE; and receive, from the UE, an ML model performance report prepared according to the ML model performance report configuration, the ML model performance report conveying a performance of a current ML model used to compress CSI, the performance being based on a comparison of the CSI with a decompressed output of the current ML model. The model performance configuration component 150 may be within one or more processors of the one or more network entities 104, such as the RU processor 1106 (e.g., at 150a), the DU processor 1126 (e.g., at 150b), and/or the CU processor 1146 (e.g., at 150c). The model performance configuration component 150a-150c may be one or more hardware components specifically configured to carry out the stated processes/algorithm, implemented by one or more processors 1106, 1126, 1146 configured to perform the stated processes/algorithm, stored within a computer-readable medium for implementation by the one or more processors 1106, 1126, 1146, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software_shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases. e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: a method of wireless communication performed by a UE, the method including: receiving an ML model performance report configuration from a network entity; and transmitting, to the network entity, an ML model performance report prepared according to the ML model performance report configuration, the ML model performance report conveying a performance of a current ML model used to compress CSI, the performance being based on a comparison of the CSI with a decompressed output of the current ML model.

Example 2 may be combined with Example 1 and includes that the transmitting of the ML model performance report is triggered by a reporting criterion being satisfied.

Example 3 may be combined with Example 1 and further includes performing an ML model performance monitoring procedure, where the transmitting of the ML model performance report is based on the performing the ML model performance monitoring procedure.

Example 4 may be combined with Example 3 and further includes initiating the ML model performance monitoring procedure when a monitoring condition is satisfied, the monitoring condition being indicated by the ML model performance report configuration.

Example 5 may be combined with Example 3 and further includes initiating the ML model performance monitoring procedure when an ML-based CSI reporting condition is satisfied, the ML-based CSI reporting condition being indicated by an ML-based CSI report configuration.

Example 6 may be combined with Example 3 and includes that the receiving of the ML model performance report configuration triggers the performing of the ML model performance monitoring procedure.

Example 7 may be combined with any of Examples 1-6 and further includes transmitting, to the network entity, an ML-based CSI report conveying compressed CSI.

Example 8 may be combined with any of Examples 1-7 and further includes receiving, from the network entity, a configuration for ML-based CSI reporting.

Example 9 may be combined with Example 8 and further includes sending, to the network entity, the ML model performance report prepared according to the configuration for the ML-based CSI reporting.

Example 10 may be combined with any of Examples 1-9 and further includes transmitting, to the network entity, UE capability information indicating at least one of an ML model performance monitoring capability, or an ML-based CSI reporting capability.

Example 11 may be combined with any of Examples 1-10 and further includes transmitting, to the network entity, a first indication that the UE prefers ML-based reporting over non-ML-based reporting.

Example 12 may be combined with any of Examples 1-10 and further includes transmitting, to the network entity, a second indication that the UE prefers non-ML-based reporting over ML-based reporting.

Example 13 may be combined with any of Examples 1-10 and further includes transmitting, to the network entity, a third indication that the UE prefers to replace the current ML model with a different ML model.

Example 14 is a method of wireless communication performed by a network entity, the method including: transmitting an ML model performance report configuration to a UE; and receiving, from the UE, an ML model performance report prepared according to the ML model performance report configuration, the ML model performance report conveying a performance of a current ML model used to compress CSI, the performance being based on a comparison of the CSI with a decompressed output of the current ML model.

Example 15 may be combined with Example 14 and includes that the receiving of the ML model performance report is associated with a reporting criterion being satisfied.

Example 16 may be combined with Example 14 and includes that the receiving of the ML model performance report is associated with an ML model performance monitoring procedure.

Example 17 may be combined with Example 16 and includes that the transmitting of the ML model performance report configuration triggers the ML model performance monitoring procedure.

Example 18 may be combined with any of Examples 14-17 and further includes receiving, from the UE, an ML-based CSI report conveying compressed CSI.

Example 19 may be combined with any of Examples 14-18 and further includes transmitting, to the UE, a configuration for ML-based CSI reporting.

Example 20 may be combined with Example 19 and further includes receiving, from the UE, the ML model performance report prepared according to the configuration for the ML-based CSI reporting.

Example 21 may be combined with any of Examples 14-20 and further includes receiving, from, UE capability information indicating at least one of an ML model performance monitoring capability, or an ML-based CSI reporting capability.

Example 22 may be combined with any of Examples 14-21 and further includes receiving, from the UE, a first indication that the UE prefers ML-based reporting over non-ML-based reporting.

Example 23 may be combined with any of Examples 14-21 and further includes receiving, from the UE, a second indication that the UE prefers non-ML-based reporting over ML-based reporting.

Example 24 may be combined with any of Examples 14-21 and further includes receiving, from the UE, a third indication that the UE prefers to replace the current ML model with a different ML model.

Example 25 is an apparatus for wireless communication for implementing a method as in any of examples 1-24.

Example 26 is an apparatus for wireless communication including means for implementing a method as in any of examples 1-24.

Example 27 is a non-transitory computer-readable medium storing computer executable code, the code when executed by a processor causes the processor to implement a method as in any of examples 1-24.

1. A method of wireless communication performed by a user equipment (UE), the method comprising:
receiving a machine learning (ML) model performance report configuration from a network entity; and
transmitting, to the network entity, an ML model performance report prepared according to the ML model performance report configuration, the ML model performance report conveying a performance of a current ML model used to compress channel state information (CSI) the performance being based on a comparison of the CSI with a decompressed output of the current ML model.

2. The method of claim 1, wherein the transmitting of the ML model performance report is triggered by a reporting criterion being satisfied.

3. The method of claim 1, further comprising:
performing an ML model performance monitoring procedure, wherein the transmitting of the ML model performance report is based on the performing ML model performance monitoring procedure.

4. The method of claim 3, further comprising:
initiating the ML model performance monitoring procedure when a monitoring condition is satisfied, the monitoring condition being indicated by the ML model performance report configuration.

5. The method of claim 3, further comprising:
initiating the ML model performance monitoring procedure when an ML-based CSI reporting condition is satisfied, the ML-based CSI reporting condition being indicated by an ML-based CSI report configuration.

6. The method of claim 3, wherein the receiving of the ML model performance report configuration triggers the performing of the ML model performance monitoring procedure.

7. The method of claim 1, further comprising:
transmitting, to the network entity, an ML-based CSI report conveying compressed CSI.

8. The method of claim 1, further comprising:
receiving, from the network entity, a configuration for ML-based CSI reporting.

9. The method of claim 8, further comprising:
sending, to the network entity, the ML model performance report prepared according to the configuration for the ML-based CSI reporting.

10. The method of claim 1, further comprising:
transmitting, to the network entity, UE capability information indicating at least one of:
an ML model performance monitoring capability, or
an ML-based CSI reporting capability.

11. The method of claim 1, further comprising:
transmitting, to the network entity, a first indication that the UE prefers ML-based reporting over non-ML-based reporting.

12. The method of claim 1, further comprising:
transmitting, to the network entity, a second indication that the UE prefers non-ML-based reporting over ML-based reporting.

13. The method of claim 1, further comprising:
transmitting, to the network entity, a third indication that the UE prefers to replace the current ML model with a different ML model.

14. A method of wireless communication performed by a network entity, the method comprising:
transmitting a machine learning (ML) model performance report configuration to a user equipment (UE); and
receiving, from the UE, an ML model performance report prepared according to the ML model performance report configuration, the ML model performance report conveying a performance of a current ML model used to compress channel state information (CSI) the performance being based on a comparison of the CSI with a decompressed output of the current ML model.

15. An apparatus for wireless communication comprising a memory, a transceiver, and a processor coupled to the memory and the transceiver, the apparatus being configured to:
receive a machine learning (ML) model performance report configuration from a network entity; and
transmit, to the network entity, an ML model performance report prepared according to the ML model performance report configuration, the ML model performance report conveying a performance of a current ML model used to compress channel state information (CSI), the performance being based on a comparison of the CSI with a decompressed output of the current ML model.

16. The apparatus of claim 15, wherein transmission of the ML model performance report is triggered by a reporting criterion being satisfied.

17. The apparatus of claim 15, wherein the processor is configured to perform an ML model performance monitoring procedure, wherein transmission of the ML model performance report is based on the performing ML model performance monitoring procedure.

18. The apparatus of claim 17, wherein the processor is configured to initiate the ML model performance monitoring procedure when a monitoring condition is satisfied, the monitoring condition being indicated by the ML model performance report configuration.

19. The apparatus of claim 17, wherein the processor is configured to initiate the ML model performance monitoring procedure when an ML-based CSI reporting condition is satisfied, the ML-based CSI reporting condition being indicated by an ML-based CSI report configuration.

20. The apparatus of claim 17, wherein the processor is configured to trigger performing of the ML model performance monitoring procedure based on receiving the ML model performance report configuration.
